(19) United States
(12) Patent Application Publication
(10) Pub. No.: US 2024/0316450 A1
(43) Pub. Date: Sep. 26, 2024

(54) GAME PROGRAM, GAME PROCESSING METHOD, AND GAME DEVICE

(71) Applicant: Konami Digital Entertainment Co., Ltd., Tokyo (JP)

(72) Inventor: Noriaki OKAMURA, Tokyo (JP)

(73) Assignee: Konami Digital Entertainment Co., Ltd., Tokyo (JP)

(21) Appl. No.: 18/575,023

(22) PCT Filed: Nov. 30, 2021
(86) PCT No.: PCT/JP2021/043823

§ 371 Date: Dec. 28, 2023

(30) Foreign Application Priority Data
Dec. 8, 2020 (JP) 2020-203591
Dec. 8, 2020 (JP) 2020-203592

(51) Int. Cl. A63F 13/213; A63F 13/428; A63F 13/814; G02B 27/01; G06T 19/00; G06V 40/20

(52) U.S. Cl. CPC A63F 13/213; A63F 13/428; A63F 13/814; G02B 27/017; G06T 19/006; G06V 40/20

(57) ABSTRACT

A game processing method performed by a computer that performs processing of a game played on a head mount device and outputs an image that is visible to the user while a real space is visible, includes acquiring a captured image of the real space, generating a virtual space corresponding to the real space from the captured image, arranging an object that instructs the user to perform a motion at a position that is based on a reference position corresponding to the user in the virtual space such that the object is visible to the user, displaying the virtual space in which the object is arranged in association with the real space, detecting a motion of a part of a body of the user from the captured image, and evaluating the detected motion based on a timing and position based on the object arranged in the virtual space.

### TECHNICAL FIELD

The present invention relates to a game program, a game processing method, and a game device.

### BACKGROUND ART

Among music games, there is a dance game that detects a body movement of a user and evaluates the quality of a dance. For example, Patent Document 1 discloses a dance game in which guidance as to the trajectory and timing that a user (player) is to draw by moving his or her hands or feet in accordance with music is displayed on a game screen that is displayed facing the user and the user moves his or her hands or feet while looking at the displayed guidance. This dance game can be played, for example, on a home game machine.

Patent Document 2 similarly discloses a dance game in which a user steps on an operation panel disposed in real space in accordance with guidance instructions displayed on a game screen in accordance with music. This dance game is an example configured as a so-called arcade game that requires that an operation panel be installed at the user's feet to determine the position of the user's feet in real space and is installed in amusement facilities such as game centers.

### CITATION LIST

### Patent Document

### Patent Document 1

Japanese Unexamined Patent Application, First Publication No. 2012-196286

### Patent Document 2

Japanese Unexamined Patent Application, First Publication No. 2016-193006

### SUMMARY OF INVENTION

### Technical Problem

However, the game described in the above Patent Document 1 is not suitable for a game that indicates the position where the user is to perform a motion (for example, the position to be stepped on with his or her foot) in real space, although it is possible to guide the user on the game screen as to which body movement (trajectory) to make at which timing. For example, when the game as described in the above Patent Document 2 is realized with a simple configuration like a home game machine without installing an operation panel at the user's feet, it may be difficult for the user to know the position to which to move his or her feet in the real space, making it difficult to play intuitively.

It is an object of some aspects of the present invention to provide a game program, a game processing method, and a game device which guide the user as to the content of a motion to be performed such that the user can play more intuitively with a simple configuration.

It is another aspect of the present invention to provide a game program, a game processing method, and a game device which can achieve advantages mentioned in the embodiments that will be described below.

### Solution to Problem

An aspects of the present invention to solve the above problems is a non-temporary storage medium storing a game program for a computer that performs processing of a game that is playable using an image output device that is worn on a head of a user to output an image to the user such that the image is visible to the user while a real space is visible, the game program causing the computer to perform the steps of acquiring a captured image of the real space, generating a virtual space corresponding to the real space from the captured image, arranging an instruction object that instructs the user to perform a motion at a position that is based on a reference position corresponding to the user in the virtual space such that the instruction object is visible to the user, displaying the virtual space in which at least the instruction object is arranged in association with the real space, detecting a motion of at least a part of a body of the user from the captured image, and evaluating the detected motion based on a timing and position that are based on the instruction object arranged in the virtual space.

Another aspect of the present invention is a game processing method performed by a computer that performs processing of a game that is playable using an image output device that is worn on a head of a user to output an image to the user such that the image is visible to the user while a real space is visible, the game processing method including the steps of acquiring a captured image of the real space, generating a virtual space corresponding to the real space from the captured image, arranging an instruction object that instructs the user to perform a motion at a position that is based on a reference position corresponding to the user in the virtual space such that the instruction object is visible to the user, displaying the virtual space in which at least the instruction object is arranged in association with the real space, detecting a motion of at least a part of a body of the user from the captured image, and evaluating the detected motion based on a timing and position that are based on the instruction object arranged in the virtual space.

Still another aspect of the present invention is a game device that performs processing of a game that is playable using an image output device that is worn on a head of a user to output an image to the user such that the image is visible to the user while a real space is visible, the game device including an acquiring unit configured to acquire a captured image of the real space, a generating unit configured to generate a virtual space corresponding to the real space from the captured image acquired by the acquiring unit, an arranging unit configured to arrange an instruction object that instructs the user to perform a motion at a position that is based on a reference position corresponding to the user in the virtual space generated by the generating unit such that the instruction object is visible to the user, a display control unit configured to display the virtual space in which at least the instruction object is arranged in association with the real space, a detecting unit configured to detect a motion of at least a part of a body of the user from the captured image acquired by the acquiring unit, and an evaluating unit configured to evaluate the motion detected by the detecting unit based on a timing and position that are based on the instruction object arranged in the virtual space.

Yet another aspect of the present invention is a game program causing a computer to perform the steps of acquiring a captured image of a real space, generating a virtual space corresponding to the real space from the captured image, arranging an instruction object that instructs a user to perform a motion at a position that is based on a reference position corresponding to the user in the virtual space such that the instruction object is visible to the user, causing a display unit to display a composite image combining the captured image and an image of the instruction object arranged in the virtual space, detecting a motion of at least a part of a body of the user from the captured image, and evaluating the detected motion based on a timing and position that are based on the instruction object arranged in the virtual space.

A further aspect of the present invention is a game processing method performed by a computer, the game processing method including the steps of acquiring a captured image of a real space, generating a virtual space corresponding to the real space from the captured image, arranging an instruction object that instructs a user to perform a motion at a position that is based on a reference position corresponding to the user in the virtual space such that the instruction object is visible to the user, causing a display unit to display a composite image combining the captured image and an image of the instruction object arranged in the virtual space, detecting a motion of at least a part of a body of the user from the captured image, and evaluating the detected motion based on a timing and position that are based on the instruction object arranged in the virtual space.

A furthermore aspect of the present invention is a game device including an acquiring unit configured to acquire a captured image of a real space, a generating unit configured to generate a virtual space corresponding to the real space from the captured image acquired by the acquiring unit, an arranging unit configured to arrange an instruction object that instructs a user to perform a motion at a position that is based on a reference position corresponding to the user in the virtual space generated by the generating unit such that the instruction object is visible to the user, a display control unit configured to cause a display unit to display a composite image combining the captured image and an image of the instruction object arranged in the virtual space, a detecting unit configured to detect a motion of at least a part of a body of the user from the captured image acquired by the acquiring unit, and an evaluating unit configured to evaluate the motion detected by the detecting unit based on a timing and position that are based on the instruction object arranged in the virtual space.

### BRIEF DESCRIPTION OF DRAWINGS

FIG. 1 is a diagram showing an overview of game processing performed by a game device according to a first embodiment.

FIG. 2 is a diagram showing the definition of spatial coordinates of a virtual space according to the first embodiment.

FIG. 3 is a block diagram showing an example of a hardware configuration of the game device according to the first embodiment.

FIG. 4 is a block diagram showing an example of a functional configuration of the game device according to the first embodiment.

FIG. 5 is a flowchart showing an example of an instruction object arranging process according to the first embodiment.

FIG. 6 is a flowchart showing an example of an instruction object display process according to the first embodiment.

FIG. 7 is a flowchart showing an example of a play evaluation process according to the first embodiment.

FIG. 8 is a diagram showing an overview of game processing performed by a 20 game device according to a second embodiment.

FIG. 9 is a diagram showing the definition of spatial coordinates of a virtual space and the position of a user image according to the second embodiment.

FIG. 10 is a block diagram showing an example of a functional configuration of the game device according to the second embodiment.

FIG. 11 is a flowchart showing an example of an instruction object arranging process according to the second embodiment.

FIG. 12 is a block diagram showing an example of a hardware configuration of a game system according to a third embodiment.

FIG. 13 is a block diagram showing an example of a functional configuration of a game device according to the third embodiment.

FIG. 14 is a diagram showing an overview of game processing performed by a game device according to a fourth embodiment.

FIG. 15 is a block diagram showing an example of a hardware configuration of the game device according to the fourth embodiment.

FIG. 16 is a block diagram showing an example of a functional configuration of the game device according to the fourth embodiment.

FIG. 17 is a flowchart showing an example of an instruction object arranging process according to the fourth embodiment.

FIG. 18 is a flowchart showing an example of an instruction object display process according to the fourth embodiment.

FIG. 19 is a flowchart showing an example of a play evaluation process according to the fourth embodiment.

### DESCRIPTION OF EMBODIMENTS

Hereinafter, embodiments of the present invention will be described with reference to the drawings.

### First Embodiment

First, a first embodiment of the present invention will be described.

### Overview of Game Device

First, an overview of an example of game processing performed by a game device according to the present embodiment will be described. The game device according to the present embodiment is typically exemplified by a home game machine, but may also be used in an amusement facility or the like such as a game center.

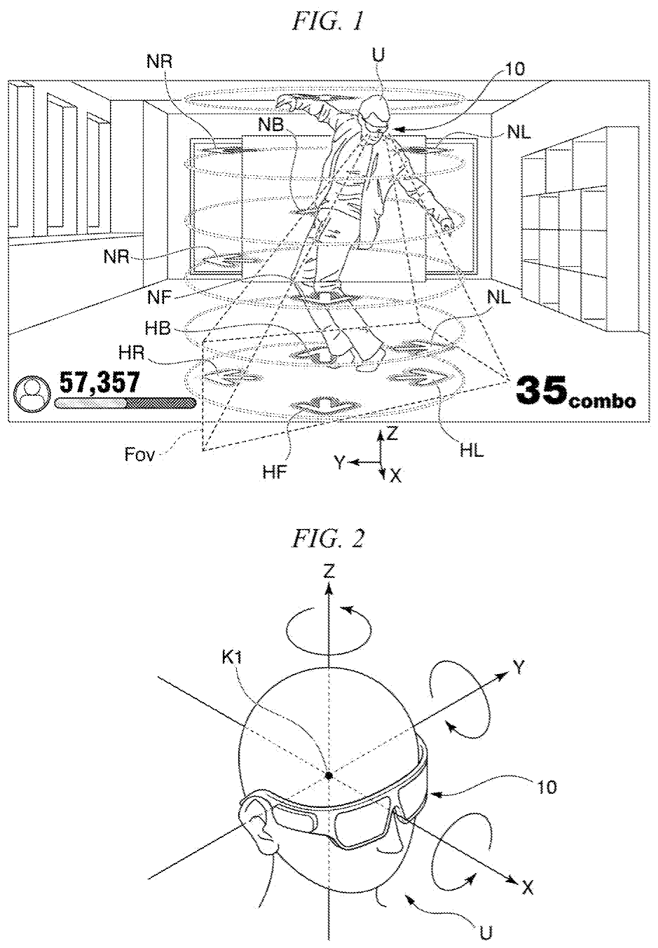

FIG. 1 is a diagram showing an overview of game processing performed by a game device according to the present embodiment. FIG. 1 shows a bird's eye view of a play situation in which a user U plays a dance game (an example of a music game) using the game device 10. The game device 10 has a configuration including an image output device. The image output device may be one that displays an image on a display or may be one that projects an image. For example, the game device 10 is configured as a head-mounted display (HMD) that is worn on the head of the user to output an image such that the image is visible to the user while a real space is visible.

In the shown dance game example, the user U moves at least a part of his or her body in accordance with the timings and positions of instruction objects displayed on the HMD in accordance with music. An instruction object is an object that is displayed to guide the user U as to the timing and position at which he or she is to perform a motion in real space. In the present embodiment, instruction objects arranged in a virtual space are displayed on the HMD in association with the real space, whereby the user can play intuitively.

For example, the game device 10 is configured as an HMD through which the real space is optically visible (a so-called optical see-through HMD). The game device 10 displays instruction objects arranged in a virtual space on a transparent display that is placed in front of the user's eyes while being worn on the head of the user. This allows the user to view an image in which instruction objects displayed on the display are superimposed on the real space that is visible through the display.

The game device 10 may also be configured as a retinal projection type of optical see-through HMD. In the case of the retinal projection type, the game device 10 includes an image projection device that projects an image directly onto the user's retina instead of a display. The instruction objects arranged in the virtual space of the user are displayed such that they are visible by being projected directly onto the user's retina.

The game device 10 may also be configured as an HMD that displays a captured image of a real space in real time (a so-called video see-through HMD). In this case, the game device 10 displays a real-time image of the real space on a display placed in front of the user's eyes while being worn on the head of the user and also displays instruction objects arranged in a virtual space such that they are superimposed on the real-time image.

The game device 10 is worn on the head of the user U and generates a virtual space from an image captured in the direction of the line of sight of the user U in the real space. For example, the virtual space is defined in a three-dimensional XYZ coordinate space defined by an X axis and a Y axis that are perpendicular to each other and parallel to a floor surface (a plane) and a Z axis that is in a vertical direction perpendicular to the floor surface (the plane). The generated virtual space includes positions corresponding to at least a part of the detected objects in the real space (such as, for example, the user U, a floor, and a wall). In the following description, as Z axis directions, a direction toward a ceiling is also referred to as an upward direction and a direction toward the floor surface is also referred to as a downward direction.

The game device 10 uses the position of the user U in this virtual space as a reference position and arranges instruction objects that instruct the user to perform motions at positions that are based on the reference position (for example, predetermined positions around the reference position). For example, the instruction objects include determination objects and mobile objects. The determination objects are each an instruction object arranged at a determination position that serves as a determination standard for evaluating the motion of the user. For example, the determination objects are arranged in a range around the reference position (the position of the user U) (for example, a range that the user U can reach by taking a step) with respect to the XY coordinates at a position (height) corresponding to the floor surface with respect to the Z coordinate in the virtual space. In the shown example, a determination object HF is arranged in front of the reference position (the position of the user U), a determination object HB is arranged behind the reference position, a determination object HR is arranged to the right of the reference position, and a determination object HL is arranged to the left of the reference position. Here, the reference position (the position of the user U) and the front, rear, right, and left with respect to the reference position are directions initialized at the start of play of this dance game and remain fixed even if the orientation of the user U changes during play.

A mobile object appears from the ceiling side in the Z coordinate in the virtual space and gradually moves downward toward a determination object (a determination position) arranged at a position (height) corresponding to the floor surface. The appearance position may be set in advance, for example, based on the position of the head of the user U (the position of the game device 10) or may change according to a predetermined rule. A mobile object NF is a mobile object that moves toward the determination object HF (a determination position of the mobile object NF). A mobile object NB is a mobile object that moves toward the determination object HB (a determination position of the mobile object NB). A mobile object NR is a mobile object that moves toward the determination object HR (a determination position of the mobile object NR). A mobile object NL is a mobile object that moves toward the determination object HL (a determination position of the mobile object NL).

The timing and position at which each mobile object reaches its determination object (determination position) while gradually moving is the timing and position at which the user U is to perform an operation. For example, the user is required to perform a motion of stepping on the determination object HF at the timing when the mobile object NF reaches the determination object HF. The motion of the user is evaluated based on the timing and position at which the mobile object reaches the determination object and a score is updated according to the evaluation. For example, the score will increase when it is determined that the timing and position of the mobile object reaching the determination object match the timing and position of the motion of the user and will not increase when it is determined that they do not match. Whether the timing and position match is determined, for example, based on whether the user has performed a motion of stepping on at least a part of a determination area (for example, the area of the determination object HR) corresponding to a position reached by the mobile object within a predetermined time corresponding to the timing at which the mobile object reaches the determination object (for example, within 0.5 seconds before or after the timing of reaching). How much the score will increase may change depending on the degree of match between the timing and position at which the mobile object reaches the determination object and the timing and position of the motion of the user.

FIG. 1 shows the correspondence between the real space including the user U and the virtual space including the instruction objects in one diagram and differs from a play screen that the user U can view while playing. Each instruction object does not exist in the real space but exists only in the virtual space and is visible through the game device 10. Instruction objects that the user U can view during an actual play are those that exist within a field of view (Fov) that is visible through a display portion of the game device 10. The game device 10 (the HMD) displays instruction objects included in this field of view, such that they are superimposed on the real space and become visible to the user U. The game device 10 also displays display information regarding the game other than the instruction objects (such as the score and information on music being played).

FIG. 2 is a diagram showing the definition of spatial coordinates of the virtual space according to the present embodiment. In the present embodiment, the axis in the vertical direction is the Z axis and the axes that are perpendicular to each other on the horizontal plane perpendicular to the Z axis are the X axis and the Y axis as described above. In initialization at the start of play of this dance game, a reference position K1 (an example of a first reference position that is based on the position of the game device 10) corresponding to the position of the user U is defined as a coordinate origin and the X axis is defined as the axis in the direction of the line of sight of the user U. The reference position K1 (the coordinate origin), the X axis, the Y axis, and the Z axis remain fixed during play. A change in a rotational direction about the Z axis is also referred to as a change in a yaw direction (a left-right direction), a change in a rotational direction about the Y axis is also referred to as a change in a pitch direction (an up-down direction), and a change in a rotational direction about the X axis is also referred to as a change in a roll direction.

When the orientation of the head of the user U wearing the game device 10 changes, the game device 10 detects changes in the rotational directions of the axes (the yaw direction, the pitch direction, and the roll direction) using a built-in acceleration sensor or the like. The game device 10 changes the field of view (Fov) shown in FIG. 1 based on the detected changes in the rotational directions of the axes and changes the display of the instruction objects included in the virtual space. Thereby, even if the orientation of the head of the user U changes, the game device 10 can display the instruction objects included in the virtual space on the display according to the change in the field of view.

A change in the yaw direction may also be referred to as a change in the left-right direction and a change in the pitch direction may also be referred to as a change in the up-down direction.

The shown reference position K1 is an example and the present invention is not limited to this position. Also, although the reference position K1 is defined as a coordinate origin of the spatial coordinates, another position may be defined as the coordinate origin.

### Hardware Configuration of Game Device 10

Next, an overview of a hardware configuration of the game device 10 according to the present embodiment will be described.

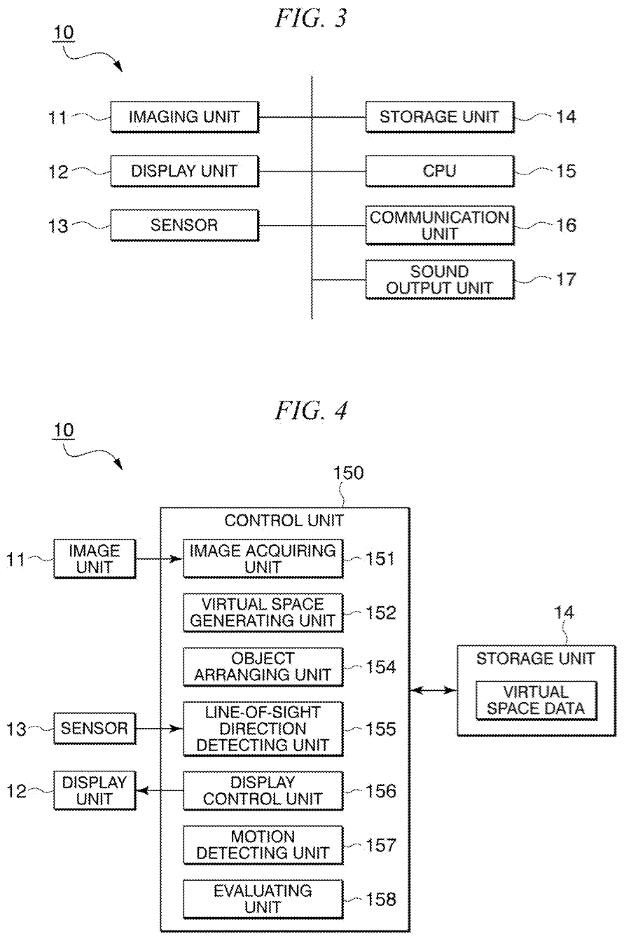

FIG. 3 is a block diagram showing an example of a hardware configuration of the game device 10 according to the present embodiment. The game device 10, which is an optical see-through HMD, is configured to include an imaging unit 11, a display unit 12, a sensor 13, a storage unit 14, a central processing unit (CPU) 15, a communication unit 16, and a sound output unit 17.

The imaging unit 11 is a camera that captures an image in the direction of the line of sight of the user U who uses the game device 10 (the HMD) by wearing it on his or her head. That is, the imaging unit 11 is provided on the game device 10 (the HMD) such that its optical axis corresponds to the direction of the line of sight when the game device 10 is worn on the head. The imaging unit 11 may be a monocular camera or a dual camera. The imaging unit 11 outputs the captured image.

The display unit 12 is, for example, a transmissive display in an optical see-through HMD. For example, the display unit 12 displays at least instruction objects. The display unit 12 may be configured to include two displays, one for the right eye and one for the left eye, or may be configured to include one display that is visible to both eyes, regardless of whether the display is for the right eye or for the left eye. When the game device 10 is a retinal projection type of optical see-through HMD, the display unit 12 is an image projection device that projects an image directly onto the user's retina.

When the game device 10 is a video see-through HMD, the display unit 12 is a non-transparent display through which the real space is optically invisible.

The sensor 13 is a sensor that outputs a detection signal regarding the direction of the game device 10. For example, the sensor 13 is a gyro sensor that detects the angle, angular velocity, angular acceleration, or the like of an object. The sensor 13 may also be a sensor that detects a change in the direction or may be a sensor that detects the direction itself. The sensor 13 may include, for example, an acceleration sensor, a tilt sensor, or a geomagnetic sensor instead of or in addition to the gyro sensor.

The storage unit 14 is, for example, an electrically erasable programmable read-only memory (EEPROM), a read-only Memory (ROM), a flash ROM, or a random access memory (RAM) and stores a program, data, generated virtual space data, or the like of this dance game.

The CPU 15 functions as a control center that controls each part of the game device 10. For example, the CPU 15 executes a program of a game stored in the storage unit 14 to perform game processing and perform processing such as processing to generate a virtual space corresponding to the real space from a captured image, processing to arrange an instruction object in the generated virtual space, and processing to detect the motion of the user and evaluate the detected motion of the user based on the timing and position of the instruction object as described above with reference to FIG. 1.

The communication unit 16 is configured to include, for example, a communication device that performs wireless communication such as Bluetooth (registered trademark) or Wi-Fi (registered trademark). The communication unit 16 may be configured to include a digital input/output port such as a universal serial bus (USB), an image input/output port, and the like.

The sound output unit 17 outputs a performance sound of played music of the dance game, the sound effects of the game, or the like. The sound output unit 17 may be configured to include, for example, a speaker, earphones, headphones, or a terminal connectable thereto. The sound output unit 17 may output various sounds to external speakers, earphones, headphones, or the like via wireless communication such as Bluetooth (registered trademark).

The hardware components included in the game device 10 described above are connected such that they can communicate with each other via a bus.

### Functional Configuration of Game Device 10

Next, a functional configuration of the game device 10 will be described with reference to FIG. 4.

FIG. 4 is a block diagram showing an example of a functional configuration of the game device 10 according to the present embodiment. The shown game device 10 includes a control unit 150 as a functional component implemented by the CPU 15 executing a program stored in the storage unit 14. The control unit 150 performs processing of the dance game described with reference to FIGS. 1 and 2. For example, the control unit 150 includes an image acquiring unit 151, a virtual space generating unit 152, an object arranging unit 154, a line-of-sight direction detecting unit 155, a display control unit 156, a motion detecting unit 157, and an evaluating unit 158.

The image acquiring unit 151 (an example of an acquiring unit) acquires a captured image of a real space that has been captured by the imaging unit 11. For example, before starting to play a dance game, the game device 10 instructs the user U to look in a predetermined direction (for example, to look up, down, left or right). The game device 10 causes, for example, the display unit 12 to display this instruction. Thus, the image acquiring unit 151 acquires the captured image in which surroundings of the user U in the real space are captured by the imaging unit 11.

The virtual space generating unit 152 (an example of a generating unit) generates a virtual space corresponding to the real space from the captured image acquired by the image acquiring unit 151. For example, the virtual space generating unit 152 detects the positions of objects (such as a floor and a wall) present in the real space from the acquired captured image and generates data on a three-dimensional coordinate space including position information of at least a part of the detected objects (such as a floor and a wall) as data on a virtual space. In an example, a reference position K1 (see FIG. 2) corresponding to the user U is defined based on the position of the game device 10 itself worn on the head of the user U as a coordinate origin of the virtual space (the three-dimensional coordinate space). The virtual space generating unit 152 generates virtual space data including position information corresponding to the objects (such as a floor and a wall) present in the real space in the virtual space (the three-dimensional coordinate space) whose coordinate origin is the reference position K1 corresponding to the user U. The virtual space generating unit 152 causes the storage unit 14 to store the generated virtual space data.

Here, any known technique can be applied to the detection method for detecting the positions of objects (such as a floor and a wall) present in the real space from the captured image. For example, when the imaging unit 11 is a dual camera (stereo camera), the positions of objects (such as a floor and a wall) may be detected by analyzing the captured image using parallax between the left and right cameras. When the imaging unit 11 is a monocular camera, detection using parallax can be performed, similar to a dual camera, using images that are captured from two locations by shifting the monocular camera by a prescribed distance. The positions of objects (such as a floor and a wall) present in the real space may be detected using laser light, sound waves, or the like instead of or in addition to image analysis.

The object arranging unit 154 (an example of an arranging unit) arranges instruction objects that instruct the user U to perform motions at positions that are based on the reference position K1 corresponding to the user U in the virtual space such that the instruction objects are visible to the user U. Specifically, the object arranging unit 154 arranges determination objects (see the determination objects HF, HB, HR, and HL in FIG. 1) at determination positions in the virtual space that correspond to positions on the floor. The object arranging unit 154 also arranges mobile objects (see the mobile objects NF, NB, NR, and NL in FIG. 1) at appearance positions in the virtual space at preset timings in accordance with music and moves them (changes their arrangement positions) toward the determination objects described above. When arranging the instruction objects (determination objects and mobile objects), the object arranging unit 154 updates the virtual space data stored in the storage unit 14 based on coordinate information of their arrangement positions in the virtual space.

The line-of-sight direction detecting unit 155 detects the orientation of the game device 10, that is, the direction of the line of sight of the user U, based on the detection signal output from the sensor 13. The line-of-sight direction detecting unit 155 may also detect the orientation of the game device 10, that is, the direction of the line of sight of the user U, by analyzing the captured image of the real space that has been captured by the imaging unit 11. For example, the line-of-sight direction detecting unit 155 may detect the position, inclination, or the like of an object or an edge of an object by analyzing the captured image and detect the orientation of the game device 10, that is, the direction of the line of sight of the user U, based on the detection result. The line-of-sight direction detecting unit 155 may also detect the position, inclination, or the like of an object or an edge of an object in each frame of the captured image to detect the difference in the position, inclination, or the like of the object or the edge of the object between each frame and detect a change in the orientation of the game device 10, that is, the direction of the line of sight of the user U, based on the detection result. The line-of-sight direction detecting unit 155 may also detect the orientation of the game device 10, that is, the direction of the line of sight of the user U, based on both the detection signal output from the sensor 13 and the analysis of the captured image in the real space.

The display control unit 156 refers to the virtual space data stored in the storage unit 14 and causes the display unit 12 to display the virtual space in which at least instruction objects are arranged in association with the real space. Here, associating the virtual space with the real space includes associating the coordinates of the virtual space generated based on the real space with the coordinates of the real space. When displaying the virtual space, the display control unit 156 determines the viewpoint position and direction of the line of sight in the virtual space based on the position and orientation of the game device 10 (the HMD), that is, the position and direction of the user U, in the real space. For example, the display control unit 156 causes the display unit 12 to display instruction objects that are arranged in a range of the virtual space corresponding to the range of a field of view (Fov) (the range of the real space) determined by the direction of the line of sight of the user U detected by the line-of-sight direction detecting unit 155 (see FIG. 1).

The motion detecting unit 157 (an example of a detecting unit) detects a motion of at least a part of the body of the user U from the captured image. For example, the motion detecting unit 157 detects a motion of a foot of the user U who plays a dance game. Any known technique can be applied to the recognition technique for recognizing at least a part of the body of the user U (that is, a recognition target) from the captured image. For example, the motion detecting unit 157 recognizes an image region of the recognition target from the captured image using feature information of the recognition target (for example, feature information of a foot). The motion detecting unit 157 detects a motion of a recognition target (for example, a motion of a foot) by extracting and tracking an image region of the recognition target from each frame of the captured image.

The evaluating unit 158 evaluates a motion of at least a part of the body of the user U detected by the motion detecting unit 157 based on a timing and position that are based on an instruction object arranged in the virtual space. For example, the evaluating unit 158 evaluates a play involving a motion of the user U by comparing the timing and position of a mobile object reaching a determination object with the timing and position of a motion of a foot of the user U (a motion of stepping on the determination object). The evaluating unit 158 increases the score when it can be determined that the timings and positions of both match based on the comparison result and does not increase the score when it can be determined that they do not match.

The evaluating unit 158 may also evaluate a play involving a motion of the user U by comparing the position of a foot of the user U at the timing when a mobile object reaches a determination object with the position of the determination object.

### Operation of Instruction Object Arranging Process

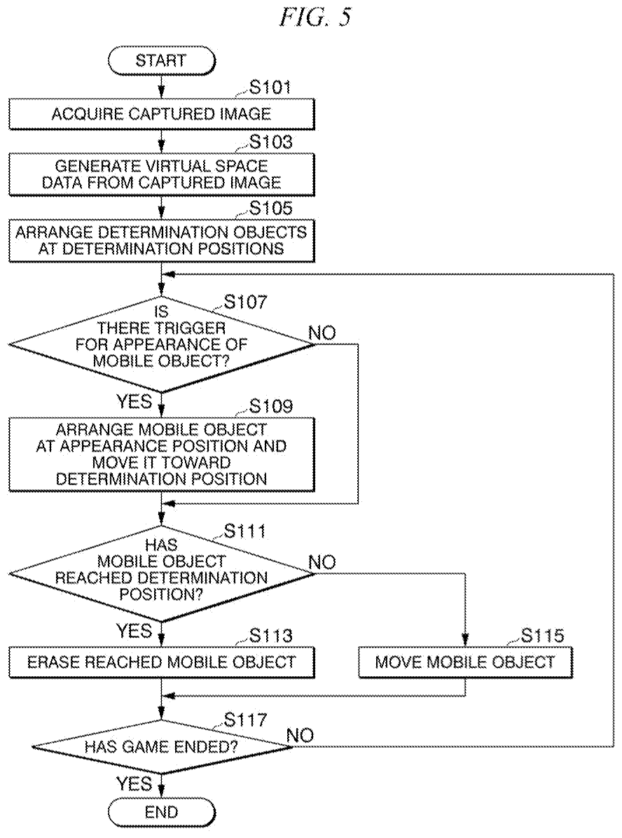

Next, an operation of an instruction object arranging process that generates a virtual space and arranges instruction objects in the processing of a dance game performed by the CPU 15 of the game device 10 will be described. FIG. 5 is a flowchart showing an example of an instruction object arranging process according to the present embodiment.

First, the CPU 15 acquires a captured image of a real space that has been captured by the imaging unit 11 (step S101). For example, before starting to play a dance game, the CPU 15 causes the display unit 12 to display an instruction for the user U to look in a predetermined direction (for example, an instruction to look up, down, left or right) and acquires the captured image in which surroundings of the user U in the real space are captured.

Next, the CPU 15 generates a virtual space corresponding to the real space from the captured image acquired in step S101 (step S103). For example, the CPU 15 detects the positions of objects (such as a floor and a wall) present in the real space from the captured image. The CPU 15 generates virtual space data of a three-dimensional coordinate space including position information of at least a part of the detected objects (such as a floor and a wall) in the virtual space (the three-dimensional coordinate space) whose coordinate origin is the reference position K1 corresponding to the user U. Then, the CPU 15 causes the storage unit 14 to store the generated virtual space data.

Subsequently, at or before the start of playing the dance game, the CPU 15 arranges determination objects (see the determination objects HF, HB, HR, and HL in FIG. 1) at determination positions that are based on the reference position K1 in the virtual space corresponding to the position of the floor (step S105). When arranging the determination objects, the CPU 15 adds position information of the arranged determination objects to the virtual space data stored in the storage unit 14.

When play of the dance game has started, the CPU 15 determines whether there is a trigger for appearance of a mobile object (step S107). An appearance trigger occurs at a preset timing in accordance with music. Upon determining in step S107 that there is an appearance trigger (YES), the CPU 15 proceeds to the process of step S109.

In step S109, the CPU 15 arranges mobile objects (one or more of the mobile objects NF, NB, NR, and NL in FIG. 1) at appearance positions that are based on the reference position K1 in the virtual space and starts moving each mobile object toward a determination position (the position of a determination object corresponding to each mobile object). When arranging a mobile object, the CPU 15 adds position information of the arranged mobile object to the virtual space data stored in the storage unit 14. Upon moving the arranged mobile object, the CPU 15 updates position information of the mobile object added to the virtual space data stored in the storage unit 14. Then, the CPU 15 proceeds to the process of step S111. On the other hand, upon determining in step S107 that there is no appearance trigger (NO), the CPU 15 proceeds to the process of step S111 without performing the process of step S109.

In step S111, the CPU 15 determines whether the mobile object has reached the determination position. The CPU 15 erases the mobile object that has been determined to have reached the determination position in step S111 (YES) from the virtual space (step S113). Upon erasing the mobile object from the virtual space, the CPU 15 deletes the position information of the erased mobile object from the virtual space data stored in the storage unit 14.

On the other hand, the CPU 15 continues to gradually move the mobile object, which has been determined not to have reached the determination position in step S111 (NO), toward the determination position (step S115). Upon moving the arranged mobile object, the CPU 15 updates position information of the moved mobile object in the virtual space data stored in the storage unit 14.

Next, the CPU 15 determines whether the dance game has ended (step S117). For example, the CPU 15 determines that the dance game has ended when the music being played has ended. Upon determining that the dance game has not ended (NO), the CPU 15 returns to the process of step S107. On the other hand, upon determining that the dance game has ended (YES), the CPU 15 ends the instruction object arranging process.

Note that a determination object and a mobile object that appears first may be arranged at the same time, the determination object may be arranged earlier, or conversely, the determination object may be arranged later (until the mobile object that appears first reaches the determination position).

### Operation of Instruction Object Display Process

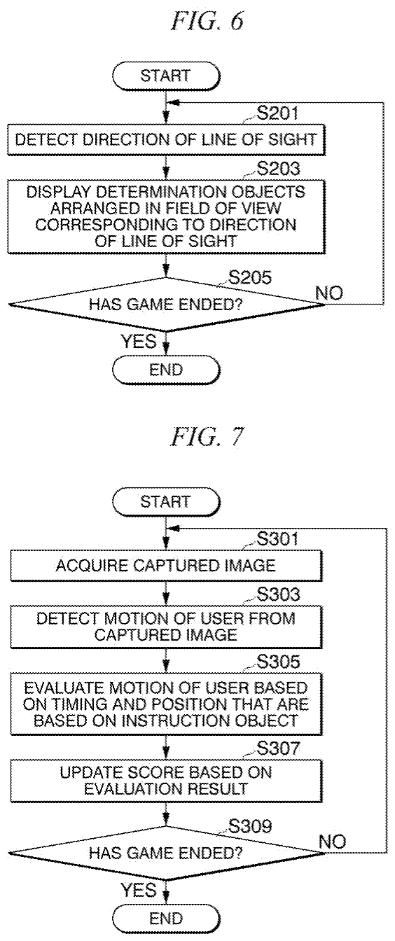

Next, an operation of an instruction object display process that displays instruction objects arranged in a virtual space in the processing of a dance game performed by the CPU 15 of the game device 10 will be described. FIG. 6 is a flowchart showing an example of an instruction object display process according to the present embodiment.

The CPU 15 detects the direction of the line of sight of the user U (the orientation of the game device 10) based on the detection signal output from the sensor 13 (step S201).

The CPU 15 refers to the virtual space data stored in the storage unit 14 and causes the display unit 12 to display a virtual space corresponding to the range of a field of view (Fov) (the range of the real space) that is based on the direction of the line of sight detected in step S201. For example, the CPU 15 causes the display unit 12 to display instruction objects (determination objects and mobile objects) arranged in a range of the virtual space corresponding to the range of the field of view (Fov) that is based on the direction of the line of sight (step S203). Thus, the mobile objects are displayed on the display unit 12 at preset timings in accordance with the music.

Next, the CPU 15 determines whether the dance game has ended (step S205). For example, the CPU 15 determines that the dance game has ended when the music being played has ended. Upon determining that the dance game has not ended (NO), the CPU 15 returns to the process of step S201. On the other hand, upon determining that the dance game has ended (YES), the CPU 15 ends the instruction object display process.

### Operation of Play Evaluation Process

Next, an operation of a play evaluation process that evaluates a play involving a motion of at least a part of the body of the user U in the processing of a dance game performed by the CPU 15 of the game device 10 will be described. FIG. 7 is a flowchart showing an example of a play evaluation process according to the present embodiment.

The CPU 15 acquires a captured image of the real space that has been captured by the imaging unit 11 (step S301). Next, the CPU 15 detects a motion of at least a part of the body of the user U from the captured image acquired in step S301 (step S303). For example, the CPU 15 detects the motion of a foot of the user U playing a dance game.

Then, the CPU 15 evaluates a motion of at least a part of the body of the user U (for example, a foot) detected in step S303 based on a timing and position that are based on an instruction object arranged in the virtual space (step S305). For example, the CPU 15 compares the timing and position of a mobile object reaching a determination object with the timing and position of a motion of a foot of the user U (a motion of stepping on the determination object) to evaluate a play involving the motion of a foot of the user U.

The CPU 15 updates the score of the game based on the evaluation result in step S305 (step S307). For example, the CPU 15 increases the score when it can be determined that the timing and position of the mobile object reaching the determination object match the timing and position of the motion of a foot of the user U (a motion of stepping on the determination object) and does not increase the score when it can be determined that they do not match.

Next, the CPU 15 determines whether the dance game has ended (step S309). For example, the CPU 15 determines that the dance game has ended when the music being played has ended. Upon determining that the dance game has not ended (NO), the CPU 15 returns to the process of step S301. On the other hand, upon determining that the dance game has ended (YES), the CPU 15 ends the play evaluation process.

### Summary of First Embodiment

As described above, the game device 10 according to the present embodiment is worn on the head of the user U to output an image to the user U such that the image is visible to the user U and performs processing of a game that is playable using the game device 10 (an example of an image output device) with which a real space is visible. For example, the game device 10 acquires a captured image of a real space and generates a virtual space corresponding to the real space from the acquired captured image. Then, the game device 10 arranges instruction objects that instruct the user U to perform motions at positions that are based on the reference position K1 corresponding to the user U in the virtual space such that the instruction objects are visible to the user and displays the virtual space in which at least the instruction objects are arranged in association with the real space. The game device 10 also detects a motion of at least a part of the body of the user U from the acquired captured image and evaluates the detected motion based on a timing and position that are based on an instruction object arranged in the virtual space.

Thus, in the game processing for evaluating a motion of the user U based on the timing and position that are based on an instruction object that instructs the user U to perform the motion, the game device 10 makes the instruction object visible to the user U in association with the real space by being worn on his or her head and therefore, with a simple configuration, it is possible to guide the user as to the content of a motion to be performed such that the user can play more intuitively.

For example, the reference position K1 is a first reference position in the virtual space that corresponds to the position of the user U wearing the game device 10 (an example of an image output device) and is based on the position of the see-through HMD in the virtual space. For example, the reference position K1 is a position in the virtual space that corresponds to the position of the user U in the real space (the position of the see-through HMD) and is defined as a coordinate origin of the virtual space (the three-dimensional coordinate space).

Thus, the game device 10 can display instruction objects in association with the real space based on the position of the user U playing the game, such that instructions for the user U to perform motions can feel realistic, allowing for more intuitive play.

The game device 10 moves an instruction object (for example, a mobile object) arranged at a predetermined position (appearance position) in the virtual space toward a predetermined determination position (for example, the position of a determination object). The game device 10 then evaluates a motion of at least a part (for example, a foot) of the body of the user U detected from the captured image based on the timing and determination position at which the instruction object (for example, a mobile object) moving in the virtual space reaches the determination position.

Thus, the game device 10 can evaluate whether the user U was able to perform a motion as instructed using the captured image.

With the game device 10, the user U can only view instruction objects within the range of a field of view that is based on the direction of the line of sight of the user and therefore cannot simultaneously view instruction objects in front of, behind, to the left, and to the right of the user U (in 3600 around the user U). Therefore, the game device 10 may limit positions at which instruction objects are arranged to a part of the virtual space depending on the orientation of the user U wearing the game device 10 (an example of an image output device). For example, based on the orientation of the user U (the reference position K1) set at the time of initialization, the game device 10 may arrange only instruction objects in front, to the right, and to the left and not arrange instruction objects behind.

Thus, the game device 10 does not issue an instruction to perform a motion outside the range of the field of view of the user U (for example, behind the user U), such that the user U can play without worrying about what is outside the range of the field of view (for example, behind the user U) during play. Accordingly, the game device 10 can prevent the difficulty level of play from becoming too high.

When the game device 10 limits positions at which instruction objects are arranged to a part of the virtual space depending on the orientation of the user U, the game device 10 may change the limited directions during play depending on the orientation of the user U. For example, when the user U is facing forward, the game device 10 may arrange only instruction objects in front of, to the right, and to the left of the user U (the reference position K1) and not arrange instruction objects behind the user U (the reference position K1). When the user U turns right, the game device 10 may arrange only instruction objects in front of, to the right, and to the left of the user U (the reference position K1) who has turned right (which are instruction objects to the right, in front of, and behind the user U before turning right) and not arrange instruction objects behind (to the left before turning right). Similarly, when the user U turns left or back, the game device 10 may not arrange instruction objects in the opposite direction (to the right or in front of the user U before changing the orientation).

Thus, following changes in the orientation of the user U, the game device 10 does not always issue an instruction to perform a motion outside the range of the field of view of the user U, such that the difficulty level of play can be limited.

### Second Embodiment

Next, a second embodiment of the present invention will be described.

In the example described in the first embodiment, instruction objects that are actually visible to the user U are limited to instruction objects that are arranged in the range of a field of view that is based on the direction of the line of sight of the user U among the instruction objects arranged in the virtual space. Therefore, for example, if an instruction object is present behind the user U, it may be difficult to recognize it. Although this difficulty can be used in terms of gameplay, there is a concern that it will become difficult for beginners or the like to play. In the first embodiment, it has been described that positions at which instruction objects are arranged may be limited to a part of the virtual space depending on the orientation of the user U to limit the difficulty, but this configuration will reduce the number of types of motions that the user U is instructed to perform during play. Moreover, when the user U actually plays, it is necessary to play while looking at his or her feet and instruction objects which are located below when viewed from the user U, which may adversely affect the motion of the body of the user U, making it difficult to dance. Thus, the present embodiment solves this problem using a mirror.

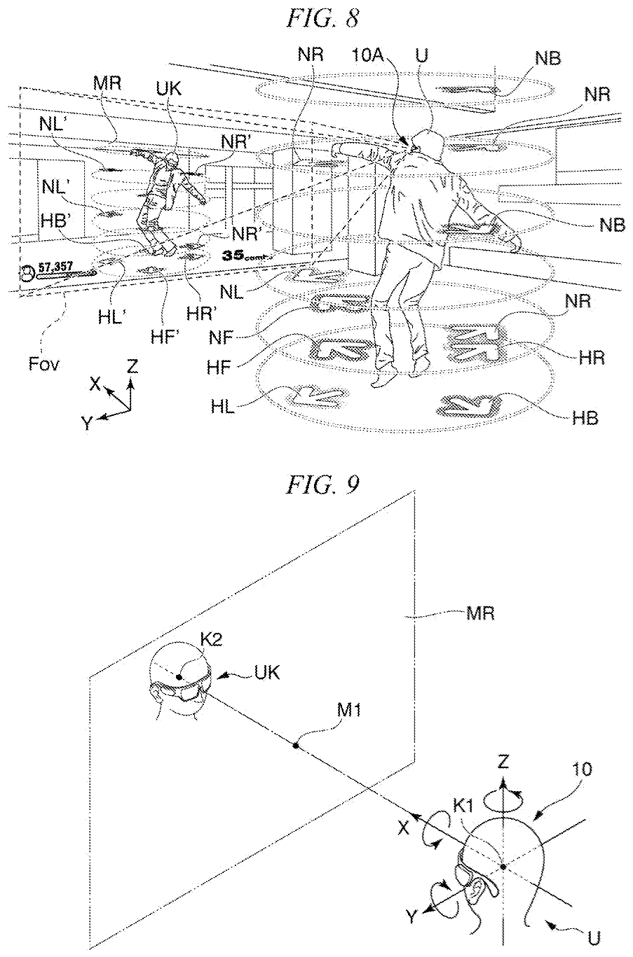

FIG. 8 is a diagram showing an overview of game processing performed by a game device according to the present embodiment. FIG. 8 shows a bird's eye view of a play situation in which a user U plays a dance game using a game device TOA according to the present embodiment. Similar to FIG. 1, FIG. 8 shows the correspondence between a real space including the user U and a virtual space including the instruction objects in one diagram and differs from a play screen that the user U can view while playing.

In the shown example, the user U is playing a dance game in a position facing a mirror MR. Similar to FIG. 1, instruction objects (determination objects and mobile objects) are arranged around the user U in the virtual space. The user U is reflected in the mirror MR present facing the user U. Here, a virtual image of the user U reflected in the mirror MR is referred to as a “user image UK.” The game device 10A detects the user image UK corresponding to the user U from a captured image obtained by imaging in a direction toward the mirror MR and arranges instruction objects around the detected user image UK as if the instruction objects arranged around the user U are reflected in the mirror MR.

FIG. 9 is a diagram showing the definition of spatial coordinates of the virtual space and the position of the user image UK according to the present embodiment. FIG. 9 is a diagram showing the definition of spatial coordinates of the virtual space shown in FIG. 2 to which the position of the user image UK detected from the captured image is added. A reference position K2 (an example of a second reference position) corresponding to the position of the user image UK in the virtual space is detected at a position ahead (inward) of the mirror MR in the X axis direction (in the direction of the line of sight) with respect to the reference position K1 (for example, the coordinate origin) corresponding to the position of the user U. For example, when a position where a mirror surface of the mirror MR intersects the X axis is a mirror position M1, the reference position K2 is detected at a position in the X axis direction where the distance from the reference position K1 to the mirror position M1 is the same as the distance from the mirror position M1 to the reference position K2. Here, the reference position K2 may be a position corresponding to the center of the head of the user image UK or a position corresponding to the center of gravity of the user image UK and can be defined at any position.

Returning to FIG. 8, the game device 10A detects an image region (a contour) and a distance of the user image UK from the captured image and detects a reference position K2 corresponding to the position of the user image UK in the virtual space separately from the reference position K1 corresponding to the position of the user U. The game device 10A then arranges instruction objects around the reference position K1 and the reference position K2 based on the reference position K1 and the reference position K2, respectively. Here, the front-back orientation of the user image UK is opposite to that of the user U since the user image UK is a virtual image of the user U reflected in the mirror MR. Therefore, the game device 10A arranges instruction objects around the reference position K2 (the position of the user image UK) such that the front-back orientations (forward and backward positional relationships in spatial coordinates) of the instruction objects arranged around the reference position K2 are reversed from those of the instruction objects arranged around the reference position K1 (the position of the user U).

For example, assuming that the direction from the reference position K1 to the reference position K2 is a positive direction in the X axis, a determination object HF and a mobile object NF arranged in front of the reference position K1 (the position of the user U) are arranged in the positive direction in the X axis with respect to the reference position K1. On the other hand, a determination object HF′ and a mobile object NF′ arranged in front of the reference position K2 (the position of the user image UK) are arranged in the negative direction in the X axis with respect to the reference position K2. Also, a determination object HB and a mobile object NB arranged behind the reference position K1 (the position of the user U) are arranged in the negative direction in the X axis with respect to the reference position K1. On the other hand, a determination object HB′ and a mobile object NB′ arranged behind the reference position K2 (the position of the user image UK) are arranged in the positive direction in the X axis with respect to the reference position K2.

On the other hand, a determination object HR and a mobile object NR arranged to the right of the reference position K1 (the position of the user U) and a determination object HR′ and a mobile object NR′ arranged to the right of the reference position K2 (the position of the user image UK) are arranged in the same direction (for example, the positive direction) of the Y axis with respect to their respective reference positions. Also, a determination object HL and a mobile object NL arranged to the left of the reference position K1 (the position of the user U) and a determination object HL′ and a mobile object NL′ arranged to the left of the reference position K2 (the position of the user image UK) are arranged in the same direction (for example, the negative direction) of the Y axis with respect to their respective reference positions. The same is true for the upward and downward positional relationships of instruction objects arranged with respect to the reference position K1 and instruction objects arranged with respect to the reference position K2.

### Configuration of Game Device 10A

Similar to the game device 10 described in the first embodiment, the game device 10A according to the present embodiment may be a device including an optical see-through HMD or a device including a video see-through HMD. Here, similar to the first embodiment, the game device 10A will be described as an optical see-through HMD. The hardware configuration of the game device 10A is similar to the example configuration shown in FIG. 3 and thus description thereof will be omitted.

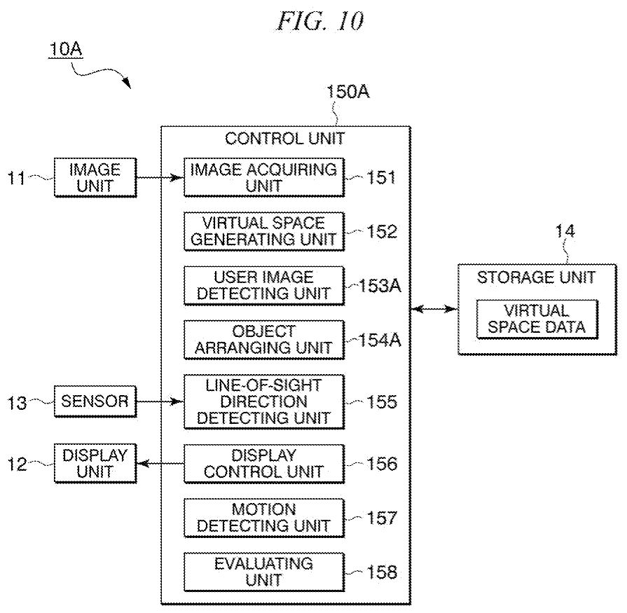

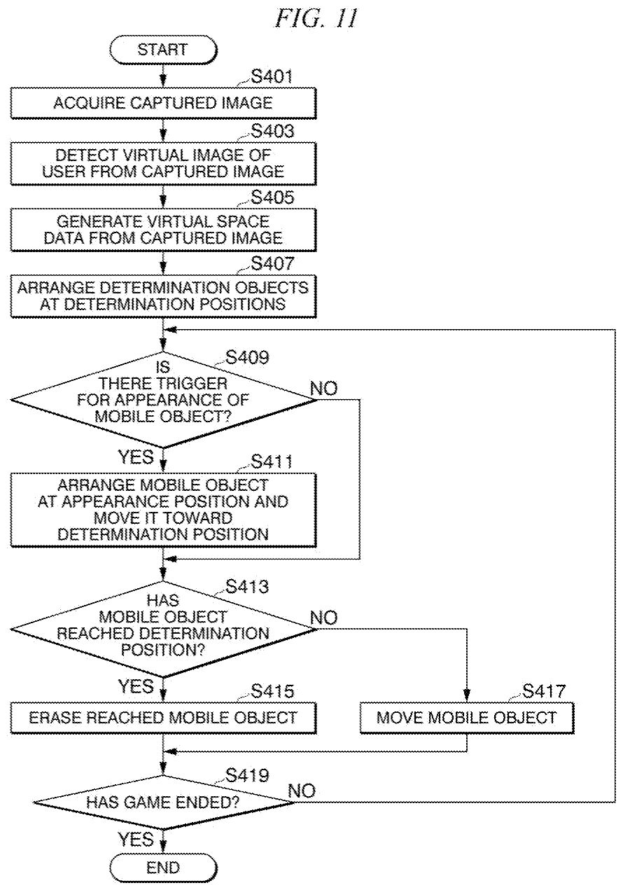

FIG. 10 is a block diagram showing an example of a functional configuration of the game device 10A according to the present embodiment. The shown game device 10A includes a control unit 150A as a functional component implemented by the CPU 15 executing a program stored in the storage unit 14. The control unit 150A includes an image acquiring unit 151, a virtual space generating unit 152, a user image detecting unit 153A, an object arranging unit 154A, a line-of-sight direction detecting unit 155, a display control unit 156, a motion detecting unit 157, and an evaluating unit 158. In FIG. 10, components corresponding to those in FIG. 4 are designated by the same reference numerals and description thereof will be omitted as appropriate. The functional configuration of the game device 10A mainly differs from that of the game device 10 shown in FIG. 4 in that the user image detecting unit 153A for detecting a reference position corresponding to the user image UK reflected in the mirror MR is added.

The user image detecting unit 153A detects a user image UK (an example of an image) corresponding to the user U from a captured image acquired by the image acquiring unit 151. For example, a user image UK which is a virtual image of the user U reflected in the mirror MR present facing the user U is detected. In this detection, it is necessary to recognize that the user image UK is a virtual image of the user U playing the dance game. In a recognition method, for example, an identifiable marker (such as a mark or a sign) may be attached to the game device TOA (HMD) or the like worn on the body of the user U or the head of the user U and the user image detecting unit 153A may detect this marker from a captured image to recognize that it is a virtual image of the user U. The user U may also be instructed to perform a specific motion (for example, raising and lowering the right hand) and the user image detecting unit 153A may detect a person who performs a motion according to the instruction from the captured image to recognize that it is a virtual image of the user U.

The virtual space generating unit 152 generates three-dimensional coordinate space data, which includes position information of the user image UK in addition to position information of at least a part of objects (such as a floor and a wall) detected from the captured image, as virtual space data. For example, the virtual space generating unit 152 detects the positions of objects (such as a floor and a wall) present in the real space from the captured image. In addition, the virtual space generating unit 152 detects the position (the reference position K2) of the user image UK detected by the user image detecting unit 153A. The method of detecting the position of the user image UK may use a detection method using the parallax of a camera (the imaging unit), similar to the method of detecting the positions of objects (such as a floor and a wall) present in the real space described above. Then, the virtual space generating unit 152 generates data on a three-dimensional coordinate space including the position information of at least a part of the detected objects (such as a floor and a wall) and the position information of the reference position K2 as data on the virtual space. In an example, the coordinate origin of the virtual space (the three-dimensional coordinate space) is assumed to be the reference position K1 corresponding to the user U, similar to the first embodiment. The virtual space generating unit 152 causes the storage unit 14 to store the generated virtual space data.

The object arranging unit 154A arranges instruction objects at positions that are based on the reference position K1 corresponding to the user U in the virtual space and also arranges instruction objects at positions that are based on the reference position K2 corresponding to the user image UK (see FIGS. 8 and 9). When arranging instruction objects at positions that are based on the reference position K2 in the virtual space, the object arranging unit 154A reverses their front-back orientations with respect to the reference position K2.

Here, the object arranging unit 154A may determine whether the detected user image UK is an image reflected in the mirror MR by issuing an instruction to perform the specific motion described above (for example, raising and lowering the right hand) and detecting a person who performs the motion from the captured image. The object arranging unit 154A may also determine that the detected user image UK is an image reflected in the mirror MR upon selecting a mirror mode (a mode in which the game is played while looking at the image reflected in the mirror MR) that has been set to be selectable in advance.

For example, when the direction of the line of sight of the user U is in a direction toward the mirror MR, the display control unit 156 causes the display unit 12 to display instruction objects arranged in the range of the virtual space corresponding to the range of the field of view in a direction toward the mirror MR. That is, the display control unit 156 can display instruction objects arranged at positions that are based on the reference position K2 corresponding to the user image UK reflected in the mirror MR such that the user U can look down and view them.

The motion detecting unit 157 detects a motion of at least a part of the body of the user U by detecting a motion of at least a part of a body of the user image UK reflected in the mirror MR from the captured image.

The evaluating unit 158 evaluates a motion of at least a part of the body of the user image UK (the user image UK reflected in the mirror MR) detected by the motion detecting unit 157 using an instruction object arranged at a position that is based on the reference position K2 corresponding to the user image UK. Specifically, the evaluating unit 158 evaluates a motion of at least a part of the body of the user image UK (the user image UK reflected in the mirror MR) based on a timing and position that are based on an instruction object arranged at a position that is based on the user image UK reflected in the mirror MR. That is, the user U can play while looking in a direction toward the mirror MR without looking at the instruction objects and the feet of the user U that are located below.

In the example shown in FIG. 8, instruction objects are arranged at both positions that are based on the reference position K1 corresponding to the user U and positions that are based on the reference position K2 corresponding to the user image UK, but the present invention is not limited to this. For example, when instruction objects are arranged at positions that are based on the reference position K2 corresponding to the user image UK, the object arranging unit 154A may not arrange instruction objects at positions that are based on the reference position K1 corresponding to the user U. That is, when instruction objects are displayed at positions that are based on the reference position K2, instruction objects at positions that are based on the reference position K1 may not be displayed. This can improve the visibility of instruction objects because instruction objects displayed on the mirror MR are not hidden by instruction objects displayed around the user U.

In addition, when instruction objects are arranged at positions that are based on the reference position K2, the object arranging unit 154A may apply a less noticeable display mode with reduced visibility to instruction objects at positions that are based on the reference position K1, such as by making them translucent or reducing their size. Here, the display control unit 156 may perform a process of changing the display mode of instruction objects.

The object arranging unit 154A (or the display control unit 156) may not display the instruction objects around the user U or make them translucent only when the mirror MR is within the range of the field of view of the user U and may display the instruction objects around the user U as usual when the mirror MR is out of the range of the field of view. This can make the instruction objects visible even if the mirror MR is out of the range of the field of view (for example, when the user U faces in a direction opposite to the direction toward the mirror MR).

### Operation of Instruction Object Arranging Process

Next, an operation of an instruction object arranging process that generates a virtual space and arranges instruction objects in the processing of a dance game performed by the CPU 15 of the game device 10A will be described. Here, an instruction object arranging process corresponding to the user U (the reference position K1) will not be described because it is the same as the process shown in FIG. 5 and an instruction object arranging process for arranging instruction objects corresponding to the user image UK reflected in the mirror MR (the reference position K2) will be described. FIG. 11 is a flowchart showing an example of an instruction object arranging process according to the present embodiment.

First, the CPU 15 acquires a captured image of a real space that has been captured by the imaging unit 11 (step S401). For example, the CPU 15 acquires a captured image that includes a user image UK (see FIG. 8) reflected in the mirror MR in the direction of the line of sight of the user U playing a dance game.

Next, the CPU 15 detects a virtual image (a user image UK) of the user U playing the dance game from the captured image acquired in step S401 (step S403).

The CPU 15 generates a virtual space corresponding to the real space from the captured image acquired in step S401 (step S405). For example, the CPU 15 detects the positions of objects (such as a floor and a wall) present in the real space from the captured image and the position of the user image UK (the reference position K2) detected in step S403 and generates data on a three-dimensional coordinate space including the position information of at least a part of the detected objects (such as a floor and a wall) and the position information of the reference position K2 as data on the virtual space. In an example, the CPU 15 generates virtual space data including the position information of at least a part of the detected objects (such as a floor and a wall) and the position information of the reference position K2 in a virtual space (a three-dimensional coordinate space) whose coordinate origin is the reference position K1 corresponding to the user U. Then, the CPU 15 causes the storage unit 14 to store the generated virtual space data.

Subsequently, at or before the start of playing the dance game, the CPU 15 arranges determination objects (see the determination objects HF′, HB′, HR′, and HL′ in FIG. 8) at determination positions that are based on the reference position K2 in the virtual space corresponding to the position of the floor (step S407). When arranging the determination objects, the CPU 15 adds position information of the arranged determination objects to the virtual space data stored in the storage unit 14.

When play of the dance game has started, the CPU 15 determines whether there is a trigger for appearance of a mobile object (step S409). An appearance trigger occurs at a preset timing in accordance with music. Upon determining in step S409 that there is an appearance trigger (YES), the CPU 15 proceeds to the process of step S411.

In step S411, the CPU 15 arranges mobile objects (one or more of the mobile objects NF′, NB′, NR′, and NL′ in FIG. 8) at appearance positions that are based on the reference position K2 in the virtual space and starts moving each mobile object toward a determination position (the position of a determination object corresponding to each mobile object). When arranging a mobile object, the CPU 15 adds position information of the arranged mobile object to the virtual space data stored in the storage unit 14. Upon moving the arranged mobile object, the CPU 15 updates position information of the mobile object added to the virtual space data stored in the storage unit 14. Then, the CPU 15 proceeds to the process of step S413. On the other hand, upon determining in step S409 that there is no appearance trigger (NO), the CPU 15 proceeds to the process of step S413 without performing the process of step S411.

In step S413, the CPU 15 determines whether the mobile object has reached the determination position. The CPU 15 erases the mobile object that has been determined to have reached the determination position (YES) from the virtual space (step S415). Upon erasing the mobile object from the virtual space, the CPU 15 deletes the position information of the erased mobile object from the virtual space data stored in the storage unit 14.

On the other hand, the CPU 15 continues to gradually move the mobile object, which has been determined not to have reached the determination position (NO), toward the determination position (step S417). Upon moving the mobile object, the CPU 15 updates position information of the moved mobile object in the virtual space data stored in the storage unit 14.

Next, the CPU 15 determines whether the dance game has ended (step S419). For example, the CPU 15 determines that the dance game has ended when the music being played has ended. Upon determining that the dance game has not ended (NO), the CPU 15 returns to the process of step S409. On the other hand, upon determining that the dance game has ended (YES), the CPU 15 ends the instruction object arranging process.

Note that a determination object and a mobile object that appears first may be arranged at the same time, the determination object may be arranged earlier, or conversely, the determination object may be arranged later (until the mobile object that appears first reaches the determination position).

### Summary of Second Embodiment

As described above, the game device 10A according to the present embodiment further detects the user image UK, which is a virtual image (an example of an image) corresponding to the user U, from the captured image of the real space. Then, the game device 10A arranges instruction objects that instruct the user U to perform motions at positions that are based on the reference position K2 of the user image UK corresponding to the user U in the virtual space such that the instruction objects are visible to the user.

Thus, by being worn on the head, the game device 10A can display instruction objects that instruct the user U to perform motions, for example, around the virtual image of the user U (the user image UK) reflected in the mirror MR and therefore, with a simple configuration, it is possible to guide the user as to the content of a motion to be performed such that the user can play more intuitively. For example, the game device 10A allows the user to simultaneously look down and view instruction objects displayed around the user image UK (for example, in front of, behind, to the left, and to the right of the user image UK) without limiting positions where the instruction objects are arranged to a part of the virtual space and therefore it is possible to diversify the types of motions that the user U is instructed to perform during play. Also, the game device 10A allows the user U to play while looking in a direction toward the mirror MR facing the user U without looking at his or her feet and instruction objects that are located below and therefore it is possible to prevent the user U from having difficulty dancing. In addition, the game device 10A displays instruction objects around the user U playing the game and around the virtual image of the user (the user image UK), for example, reflected in the mirror MR, thus allowing the user to play while arbitrarily selecting whichever of the instruction objects is easier to play.

The mirror MR may be other than a mirror as long as it has a mirror effect (specular reflection). For example, when the user U plays at a position facing a window glass in a brightly lit room at night (when it is dark outside), the window glass may be used as a mirror MR and a virtual image of the user U reflected in the window glass may be used.

When arranging instruction objects at positions (around the user image UK) that are based on the reference position K2 in the virtual space, the game device 10A reverses the front-back orientations of the instruction objects with respect to the reference position K2. Thus, the game device 10A can display instruction objects in correspondence with the orientation of the user image UK reflected in the mirror MR, such that it is possible to guide the user as to the content of a motion to be performed such that the user can play more intuitively.

When arranging instruction objects at positions (around the user image UK) that are based on the reference position K2 in the virtual space, the game device 10A may reduce the visibility of instruction objects arranged at positions (around the user U) that are based on the reference position K1. For example, the game device 10A may apply a less noticeable display mode with reduced visibility to instruction objects at positions that are based on the reference position K1, such as by making them translucent or reducing their size. Also, when arranging instruction objects at positions (around the user image UK) that are based on the reference position K2 in the virtual space, the game device 10A may not arrange instruction objects at positions (around the user U) that are based on the reference position K1.

This can improve the visibility of instruction objects because the game device 10A can prevent instruction objects displayed on the mirror MR from being hidden by instruction objects displayed around the user U.

Although the present embodiment has been described with regard to a mode in which instruction objects are arranged in the virtual space in association with a user image UK (a virtual image) of the user reflected in the mirror MR, it is also possible to employ a mode in which instruction objects are arranged in the virtual space in association with an image of the user U displayed on a monitor (a display device) instead of the mirror MR. For example, the game device 10A further includes a camera (an imaging device) that images the user U in a real space and a monitor (a display device) that displays the captured image in real time on the side facing the user U and displays the image of user U captured by the camera on the monitor. Then, the game device 10A may detect the image of the user U from an image displayed on the monitor instead of detecting the user image UK reflected in the mirror MR (the virtual image of the user U) and arrange instruction objects in the virtual space in association with the detected image of the user U. In this case, the position of the image of the user U displayed on the monitor serves as the reference position. The left-right orientation of the image of the user U displayed on the monitor is opposite to the user image UK of the user U reflected in the mirror MR. Therefore, the game device 10A reverses the left-right orientations, in addition to the front-back orientations, of instruction objects arranged in association with the image of the user U displayed on the monitor with respect to instruction objects arranged in association with the user U.

The game mode in which instruction objects are arranged using the mirror MR in the present embodiment, the game mode in which instruction objects are arranged using the monitor descried above, and the game mode described in the first embodiment (the mode of game processing performed by the game device 10) in which instruction objects are arranged without using either a mirror or a monitor differ in the manner of displaying instruction objects (such as a reference position for arranging instruction objects and whether to reverse the front-back orientation or the left-right orientation). Therefore, when a game device has two or more of the game modes (for example, when the configuration of the game device 10 and the configuration of the game device 10A are combined), it may be configured to allow the user to select in advance which mode to use before starting a dance game. This enables smooth detection of the user image UK reflected in the mirror MR or the image of the user U displayed on the monitor and can also reduce misrecognition.

### Third Embodiment

Next, a third embodiment of the present invention will be described.

Although the first and second embodiments have been described with respect to examples in which the game device 10 (10A) is configured as a single device that is a see-through HMD, it may be configured as a separate device connected to the see-through HMD by wire or wirelessly.

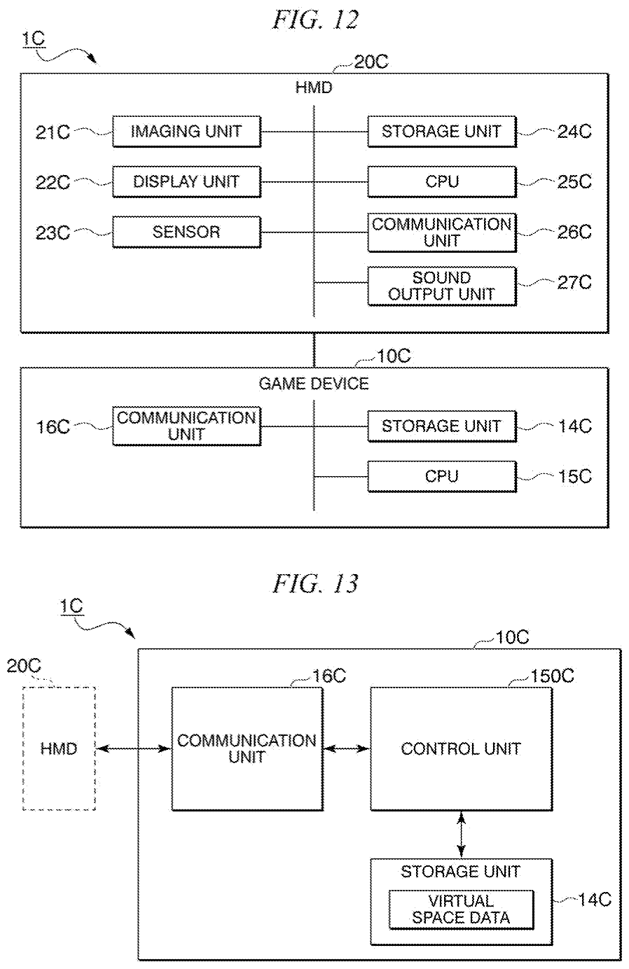

FIG. 12 is a block diagram showing an example of a hardware configuration of a game system including a game device 10C according to the present embodiment. The game device 10C is configured not to include an image output device. The shown game system 1C includes the game device 10C and an HMD 20C which is an image output device. The HMD 20C is, for example, a see-through HMD.

The HMD 20C includes an imaging unit 21C, a display unit 22C, a sensor 23C, a storage unit 24C, a CPU 25C, a communication unit 26C, and a sound output unit 27C. The imaging unit 21C, the display unit 22C, the sensor 23C, and the sound output unit 27C correspond to the imaging unit 11, the display unit 12, the sensor 13, and the sound output unit 17 shown in FIG. 3, respectively. The storage unit 24C temporarily stores data on a captured image captured by the imaging unit 21C, display data acquired from the game device 10C, and the like. The storage unit 24C also stores a program or the like necessary to control the HMD 20C. The CPU 25C functions as a control center that controls each part of the HMD 20C. The communication unit 26C communicates with the game device 10C using wired or wireless communication. The HMD 20C transmits the captured image captured by the imaging unit 21C, a detection signal of the sensor 23C, and the like to the game device 10C via the communication unit 26C. The HMD 20C also acquires display data, sound data, or the like of the dance game from the game device 10C via the communication unit 26C.

The game device 10C includes a storage unit 14C, a CPU 15C, and a communication unit 16C. The storage unit 14C stores dance game programs and data, generated virtual space data, and the like. The CPU 15C functions as a control center that controls each part of the game device 10C. For example, the CPU 15C executes a program of a game stored in the storage unit 14C to perform game processing and perform processing such as processing to generate a virtual space corresponding to the real space from a captured image, processing to arrange an instruction object in the generated virtual space, and processing to detect the motion of the user and evaluate the detected motion of the user U based on the timing and position of the instruction object. The communication unit 16C communicates with the HMD 20C using wired or wireless communication. The game device 10C acquires a captured image captured by the imaging unit 21C of the HMD 20C, a detection signal of the sensor 23C, and the like via the communication unit 16C. The game device 10C also transmits display data, sound data, or the like of the dance game to the HMD 20C via the communication unit 16C.

FIG. 13 is a block diagram showing an example of a functional configuration of the game device 10C according to the present embodiment. The shown game device 10C includes a control unit 150C as a functional component implemented by the CPU 15C executing a program stored in the storage unit 14C. The configuration of the control unit 150C is similar to that of the control unit 150 shown in FIG. 4 or the control unit 150A shown in FIG. 10 except that it exchanges data with each unit included in the HMD 20C (such as the imaging unit 21C, the display unit 22C, the sensor 23C, and the sound output unit 27) via the communication unit 16C.

As described above, the game device 10C may be configured as a separate device that communicates with the HMD 20 which is an external device. For example, a smartphone, a personal computer (PC), or a home game machine can be applied to the game device 10C.

### Fourth Embodiment

Next, a fourth embodiment of the present invention will be described.

While modes using an HMD worn on the head have been described above in the first to third embodiments, a mode not using an HMD will be described in the present embodiment.

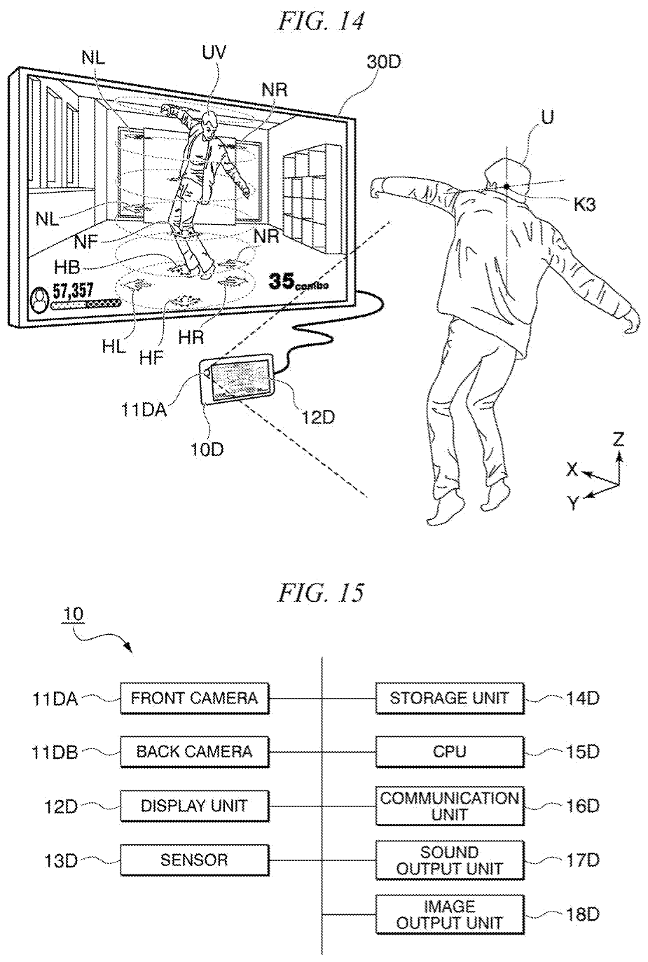

FIG. 14 is a diagram showing an overview of game processing performed by a game device according to the present embodiment. FIG. 14 shows a bird's eye view of a play situation in which a user U plays a dance game using a game device 10D. The shown game device 10D is an example where a smartphone is applied. In the present embodiment, instruction objects arranged in the virtual space are displayed on a display unit 12D or a monitor 30D of the game device 10D in association with an image of the user U captured by a front camera 11DA included in the game device 10D, such that the user can play intuitively. The monitor 30D is an external display unit (a display device) that can be connected to the game device 10D by wire or wirelessly. For example, the monitor 30D has a display with a larger screen than the display unit 12D provided on the game device 10D.

The game device 10D recognizes an image region of the user U from the captured image of the user U. Then, the game device 10D defines a reference position K3 corresponding to the position of the user U in the virtual space, generates virtual space (three-dimensional XYZ space) data in which instruction objects are arranged at positions that are based on the reference position K3, and displays the generated virtual space data superimposed on the captured image. Here, the reference position K3 may be a position corresponding to the center of the head of the user U or a position corresponding to the center of gravity of the user U and can be defined at any position.

In the shown example, instruction objects are displayed on the display unit 12D of the game device 10D, while they are also displayed on the monitor 30D with a larger screen than the game device 10D, thus increasing the visibility of instruction objects to the user U. This will be described with reference to the display screen of the monitor 30D. A user image UV indicates an image of the user U included in the captured image. An image in which instruction objects arranged at positions that are based on the reference position K3 of the user U in the virtual space are superimposed on the captured image is displayed around the user image UV.

For example, the captured image captured by the front camera 11DA can be reversed left to right as on the mirror. A determination object HR and a mobile object NR that instruct the user U to perform a rightward motion are displayed on the right side of the user image UV when facing toward the screen of the monitor 30D and a determination object HL and a mobile object NL that instruct the user U to perform a leftward motion are displayed on the left side of the user image UV. In addition, a determination object HF and a mobile object NF that instruct the user U to perform a forward motion are displayed on the front side of the user image UV when facing toward the screen of the monitor 30D and a determination object HB and a mobile object NB that instruct the user U to perform a backward motion are displayed on the back side of the user image UV.

In the present embodiment, instruction objects arranged in the virtual space can be displayed in association with the image of the user U as described above, similar to when instruction objects are displayed around the user image UK reflected in the mirror MR shown in FIG. 8, and therefore it is possible to guide the user as to the content of a motion to be performed such that the user can play intuitively.

Here, such instruction objects may be displayed on either the game device 10D or the monitor 30D.

### Hardware Configuration of Game Device 10D

A hardware configuration of the game device 10D will be described with reference to FIG. 15.

FIG. 15 is a block diagram showing an example of a hardware configuration of the game device 10D according to the present embodiment. The game device 10D includes two imaging units, the front camera 11DA and a back camera 11DB, the display unit 12D, a sensor 13D, a storage unit 14D, a CPU 15D, a communication unit 16D, a sound output unit 17D, and an image output unit 18D.

The front camera 11DA is provided on a surface (a front surface) of the game device 10D where the display unit 12D is provided and images in a direction in which the display unit 12D faces. The back camera 11DB is provided on the opposite surface (a back surface) of the game device 10D to the surface on which the display unit 12D is provided and images in a direction in which the back surface faces.

The display unit 12D is configured to include a liquid crystal display, an organic EL display, or the like. For example, the display unit 12D may be configured as a touch panel that detects touch operations on the display screen.

The sensor 13D is a sensor that outputs a detection signal regarding the direction of the game device 10D. The sensor 13D may include, for example, one or more of a gyro sensor, an acceleration sensor, a tilt sensor, and a geomagnetic sensor.

The storage unit 14D includes, for example, an EEPROM, a ROM, a flash ROM, or a RAM and stores a program, data, generated virtual space data, or the like of this dance game.

The CPU 15D functions as a control center that controls each part of the game device 10D. For example, the CPU 15D executes a program of a game stored in the storage unit 14D to perform game processing and perform processing such as superimposing and displaying instruction objects arranged on the virtual space on the captured image of the user U as described with reference to FIG. 14.

The communication unit 16D is configured to include, for example, a communication device that performs wireless communication such as Bluetooth (registered trademark) or Wi-Fi (registered trademark).

The sound output unit 17D outputs a performance sound of played music of the dance game, the sound effects of the game, or the like. The sound output unit 17 is configured to include, for example, a terminal to which a speaker, earphones, headphones, or the like are connected.

The image output unit 18D is configured to include an image output terminal that outputs the image displayed on the display unit 12D to an external display device (for example, the monitor 30D shown in FIG. 14). The image output terminal may be a dual-purpose terminal also including an output other than the image output or may be a terminal dedicated to image output.

### Functional Configuration of Game Device 10D

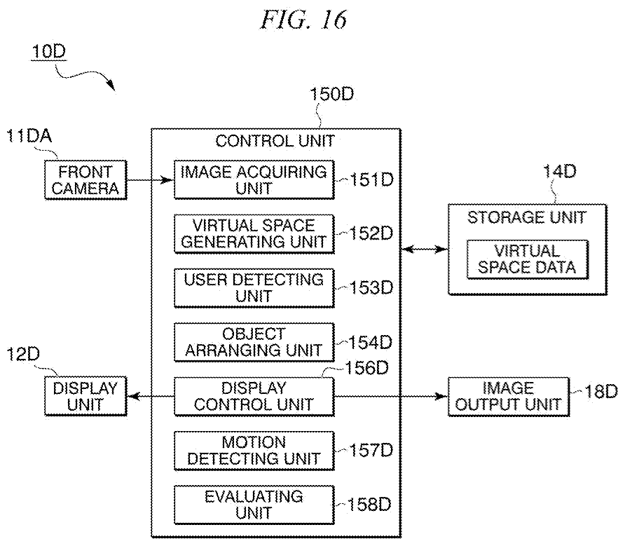

Next, a functional configuration of the game device 10D will be described with reference to FIG. 16.

FIG. 16 is a block diagram showing an example of a functional configuration of the game device 10D according to the present embodiment. The shown game device 10D includes a control unit 150D as a functional component implemented by the CPU 15D executing a program stored in the storage unit 14D. The control unit 150D includes an image acquiring unit 151D, a virtual space generating unit 152D, a user detecting unit 153D, an object arranging unit 154D, a display control unit 156D, a motion detecting unit 157D, and an evaluating unit 158D.

The image acquiring unit 151D (an example of an acquiring unit) acquires a captured image of the real space that has been captured by the front camera 11DA. For example, the image acquiring unit 151D acquires a captured image that includes a user U playing a dance game as shown in FIG. 14.

The virtual space generating unit 152D (an example of a generating unit) generates a virtual space corresponding to the real space from the captured image acquired by the image acquiring unit 151D. For example, the virtual space generating unit 152D detects the positions of objects (such as a floor and a wall) present in the real space from the acquired captured image and generates data on a three-dimensional coordinate space including position information of at least a part of the detected objects (such as a floor and a wall) as data on a virtual space. In an example, upon initialization at the start of play of this dance game, the virtual space generating unit 152D defines a reference position K3 corresponding to the user U that the user detecting unit 153D has detected from the captured image as a coordinate origin of a virtual space (a three-dimensional XYZ coordinate space) to generate virtual space data. During play, the reference position K3 (the coordinate origin) and the X, Y, and Z axes remain fixed. The virtual space generating unit 152D stores the generated virtual space data in the storage unit 14D.

The user detecting unit 153D detects an image of the user U from the captured image acquired by the image acquiring unit 151D. In this detection, it is necessary to recognize that an image of a person detected from the captured image is an image of the user U playing the dance game. In a method of recognizing that the detected image is an image of the user U, for example, an identifiable marker (such as a mark or a sign) may be attached to the body of the user U or the like and the user detecting unit 153D may detect this marker from a captured image to recognize that it is an image of the user U. The user U may also be instructed to perform a specific motion (for example, raising and lowering the right hand) and the user detecting unit 153D may detect a person who performs a motion according to the instruction from the captured image to recognize that it is an image of the user U.

The object arranging unit 154D (an example of an arranging unit) arranges instruction objects at positions that are based on the reference position K3 corresponding to the user U in the virtual space such that the instruction objects are visible to the user U. Specifically, the object arranging unit 154D arranges determination objects (see the determination objects HF, HB, HR, and HL in FIG. 14) at determination positions in the virtual space that correspond to positions on the floor. The object arranging unit 154D also arranges mobile objects (see the mobile objects NF, NB, NR, and NL in FIG. 14) at appearance positions in the virtual space at preset timings in accordance with music and moves them (changes their arrangement positions) toward the determination objects described above. When arranging the instruction objects (determination objects and mobile objects), the object arranging unit 154D updates the virtual space data stored in the storage unit 14D based on coordinate information of their arrangement positions in the virtual space.

The display control unit 156D generates a composite image by combining the captured image acquired by the image acquiring unit 151D and an image of the instruction objects arranged in the virtual space by the object arranging unit 154D. Then, the display control unit 156D causes the display unit 12D to display the generated composite image. The display control unit 156D also outputs the generated composite image through the image output unit 18D. For example, the display control unit 156D reverses the generated composite image left to right and displays it on the display unit 12D. Similarly, the display control unit 156D reverses the generated composite image left to right and outputs it through the image output unit 18D.

The motion detecting unit 157D (an example of a detecting unit) detects a motion of at least a part of the body of the user U from the captured image acquired by the image acquiring unit 151D. For example, the motion detecting unit 157D detects a motion of a foot of the user U who plays a dance game. The motion detecting unit 157D detects a motion of the foot by extracting and tracking an image region of the foot from each frame of the captured image.

The evaluating unit 158D evaluates a motion of at least a part of the body of the user U detected by the motion detecting unit 157D based on a timing and position that are based on an instruction object arranged in the virtual space. For example, the evaluating unit 158D evaluates a play involving a motion of the user U by comparing the timing and position of a mobile object reaching a determination object with the timing and position of a motion of a foot of the user U (a motion of stepping on the determination object). The evaluating unit 158D increases the score when it can be determined that the timings and positions of both match based on the comparison result and does not increase the score when it can be determined that they do not match.

The evaluating unit 158D may also evaluate a play involving a motion of the user U by comparing the position of a foot of the user U at the timing when a mobile object reaches a determination object with the position of the determination object.

### Operation of Instruction Object Arranging Process

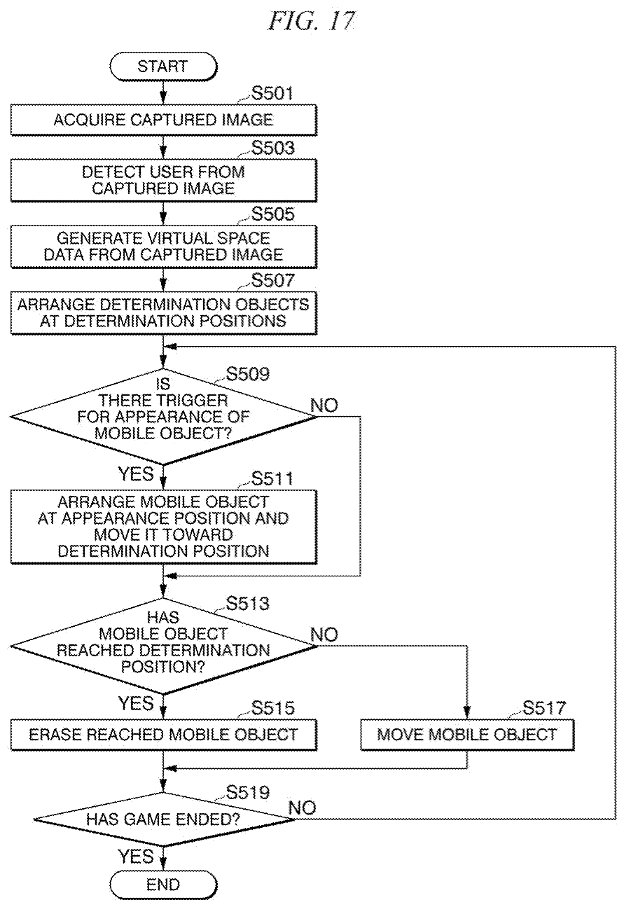

Next, an operation of an instruction object arranging process that generates a virtual space and arranges instruction objects in the processing of a dance game performed by the CPU 15D of the game device 10D will be described. FIG. 17 is a flowchart showing an example of an instruction object arranging process according to the present embodiment.

First, the CPU 15D acquires a captured image of the real space that has been captured by the front camera 11DA (step S501). For example, the CPU 15 acquires a captured image that includes a user U playing a dance game as shown in FIG. 14.

Next, the CPU 15D detects an image of the user U playing the dance game from the captured image acquired in step S501 (step S503).

Next, the CPU 15D generates a virtual space corresponding to the real space from the captured image acquired in step S501 (step S505). For example, the CPU 15D detects the positions of objects (such as a floor and a wall) present in the real space from the captured image and generates data on a three-dimensional coordinate space including position information of at least a part of the detected objects (such as a floor and a wall) as virtual space data. In an example, the CPU 15D generates virtual space data including position information of at least a part of the detected objects (such as a floor and a wall) in the virtual space (the three-dimensional coordinate space) whose coordinate origin is the reference position K3 corresponding to the user U that the user detecting unit 153D has detected from the captured image. Then, the CPU 15D causes the storage unit 14D to store the generated virtual space data.

Subsequently, at or before the start of playing the dance game, the CPU 15D arranges determination objects (see the determination objects HF, HB, HR, and HL in FIG. 14) at determination positions that are based on the reference position K3 in the virtual space corresponding to the position of the floor (step S507). When arranging the determination objects, the CPU 15D adds position information of the arranged determination objects to the virtual space data stored in the storage unit 14D.

When play of the dance game has started, the CPU 15D determines whether there is a trigger for appearance of a mobile object (step S509). An appearance trigger occurs at a preset timing in accordance with music. Upon determining in step S509 that there is an appearance trigger (YES), the CPU 15D proceeds to the process of step S511.

In step S511, the CPU 15D arranges mobile objects (one or more of the mobile objects NF, NB, NR, and NL in FIG. 14) at appearance positions that are based on the reference position K3 in the virtual space and starts moving each mobile object toward a determination position (the position of a determination object corresponding to each mobile object). When arranging a mobile object, the CPU 15D adds position information of the arranged mobile object to the virtual space data stored in the storage unit 14D. Upon moving the arranged mobile object, the CPU 15D updates position information of the mobile object added to the virtual space data stored in the storage unit 14D. Then, the CPU 15D proceeds to the process of step S513. On the other hand, upon determining in step S509 that there is no appearance trigger (NO), the CPU 15D proceeds to the process of step S513 without performing the process of step S511.

In step S513, the CPU 15D determines whether the mobile object has reached the determination position. The CPU 15D erases the mobile object that has been determined to have reached the determination position (YES) from the virtual space (step S515). Upon erasing the mobile object from the virtual space, the CPU 15D deletes the position information of the erased mobile object from the virtual space data stored in the storage unit 14D.

On the other hand, the CPU 15D continues to gradually move the mobile object, which has been determined not to have reached the determination position (NO), toward the determination position (step S517). Upon moving the mobile object, the CPU 15D updates position information of the moved mobile object in the virtual space data stored in the storage unit 14D.

Next, the CPU 15D determines whether the dance game has ended (step S519). For example, the CPU 15D determines that the dance game has ended when the music being played has ended. Upon determining that the dance game has not ended (NO), the CPU 15D returns to the process of step S509. On the other hand, upon determining that the dance game has ended (YES), the CPU 15D ends the instruction object arranging process.

Note that a determination object and a mobile object that appears first may be arranged at the same time, the determination object may be arranged earlier, or conversely, the determination object may be arranged later (until the mobile object that appears first reaches the determination position).

### Operation of Instruction Object Display Process

Next, an operation of an instruction object display process that displays instruction objects arranged in a virtual space in the processing of a dance game performed by the CPU 15D of the game device 10D will be described. In the present embodiment, instruction objects are displayed as a composite image in which instruction objects are superimposed on a captured image of the user U.

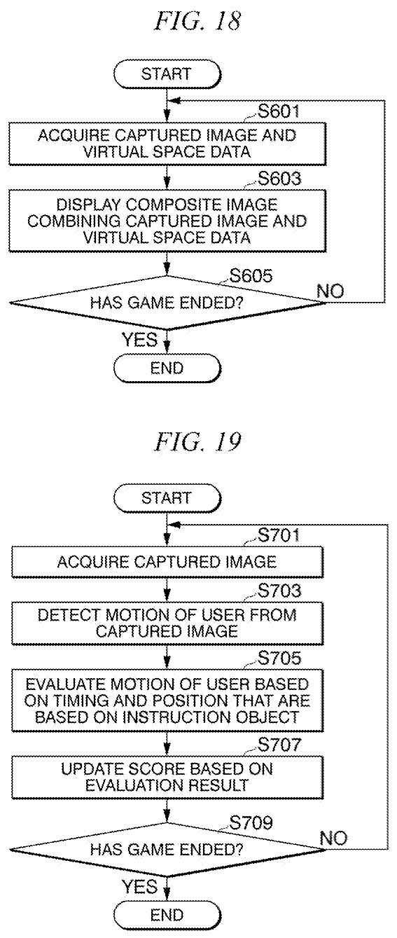

FIG. 18 is a flowchart showing an example of an instruction object display process according to the present embodiment.

The CPU 15D acquires the captured image of a real space that has been captured by the front camera 11DA and also acquires virtual space data from the storage unit 14D (step S601).

Then, the CPU 15D generates a composite image by combining the acquired captured image and the instruction objects included in the virtual space data and causes the display unit 12D to display the generated composite image (step S603). The CPU 15D also outputs the generated composite image to the image output unit 18D and causes the monitor 30D connected to the image output unit 18D to display the generated composite image (step S603). Thus, the composite image in which the instruction objects are superimposed on the captured image of the user U is displayed on the display unit 12D and the monitor 30D in real time. Here, the CPU 15D may display the composite image on either the display unit 12D or the monitor 30D.

Next, the CPU 15D determines whether the dance game has ended (step S605). For example, the CPU 15D determines that the dance game has ended when the music being played has ended. Upon determining that the dance game has not ended (NO), the CPU 15D returns to the process of step S601. On the other hand, upon determining that the dance game has ended (YES), the CPU 15D ends the instruction object display process.

### Operation of Play Evaluation Process

Next, an operation of a play evaluation process that evaluates a play involving a motion of at least a part of the body of the user U in the processing of a dance game performed by the CPU 15D of the game device 10D will be described. FIG. 19 is a flowchart showing an example of a play evaluation process according to the present embodiment.

The CPU 15D acquires a captured image of the real space that has been captured by the front camera 11DA (step S701). Next, the CPU 15D detects a motion of at least a part of the body of the user U from the captured image acquired in step S701 (step S703). For example, the CPU 15D detects the motion of a foot of the user U playing a dance game.

Then, the CPU 15D evaluates a motion of at least a part of the body of the user U (for example, a foot) detected in step S703 based on a timing and position that are based on an instruction object arranged in the virtual space (step S705). For example, the CPU 15D compares the timing and position of a mobile object reaching a determination object with the timing and position of a motion of a foot of the user U (a motion of stepping on the determination object) to evaluate a play involving the motion of a foot of the user U.

The CPU 15D updates the score of the game based on the evaluation result in step S705 (step S707). For example, the CPU 15D increases the score when it can be determined that the timing and position of the mobile object reaching the determination object match the timing and position of the motion of a foot of the user U (a motion of stepping on the determination object) and does not increase the score when it can be determined that they do not match.

Next, the CPU 15D determines whether the dance game has ended (step S709). For example, the CPU 15D determines that the dance game has ended when the music being played has ended. Upon determining that the dance game has not ended (NO), the CPU 15D returns to the process of step S701. On the other hand, upon determining that the dance game has ended (YES), the CPU 15D ends the play evaluation process.

### Summary of Fourth Embodiment

As described above, the game device 10D according to the present embodiment acquires a captured image of a real space and generates a virtual space corresponding to the real space from the acquired captured image. Then, the game device 10D arranges instruction objects that instruct the user U to perform motions at positions that are based on the reference position K3 corresponding to the user in the generated virtual space such that the instruction objects are visible to the user U and causes the display unit 12D (an example of a display unit) to display a composite image combining the captured image and an image of the instruction objects arranged in the virtual space. The game device 10D may also display the composite image on the monitor 30D (an example of a display unit). The game device 10D also detects a motion of at least a part of the body of the user U from the acquired captured image and evaluates the detected motion based on a timing and position that are based on an instruction object arranged in the virtual space.

Thus, in the game processing for evaluating a motion of the user U based on the timing and position that are based on an instruction object that instructs the user U to perform the motion, the game device 10D causes the game device 10D (for example, a smartphone) or the externally connected monitor 30D (for example, a home television) to visibly display a composite image that combines instruction objects with a captured image of the user U and therefore, with a simple configuration, it is possible to guide the user as to the content of a motion to be performed such that the user can play more intuitively.

For example, the game device 10D reverses the composite image left to right and displays the reversed composite image on the display unit 12D or the monitor 30D.

Thus, the game device 10D allows the user U to play while looking at the display unit 12D or the monitor 30D with the same feeling as looking at a mirror.

The game device 10 moves an instruction object (for example, a mobile object) arranged at a predetermined position (appearance position) in the virtual space toward a predetermined determination position (for example, the position of a determination object). The game device 10 then evaluates a motion of at least a part (for example, a foot) of the body of the user U detected from the captured image based on the timing and determination position at which the instruction object (for example, a mobile object) moving in the virtual space reaches the determination position.

Thus, the game device 10D can evaluate whether the user U was able to perform a motion as instructed using the captured image.

### Modifications

Although embodiments of the present invention have been described above in detail with reference to the drawings, the specific configurations thereof are not limited to the above embodiments and also include designs or the like without departing from the spirit of the present invention. For example, the configurations described in the above embodiments can be combined arbitrarily.

Instruction objects described in each of the above embodiments are merely examples and may be in various forms as long as they instruct the user U to perform a motion. For example, the content of the motion that the user U is instructed to perform varies depending on the type (form) of the instruction object. For example, changing the thickness (the width in the Z axis direction) of a mobile object will change the period from when the bottom of the mobile object reaches a determination object until the top of the mobile object reaches the determination object and therefore how long the user is to continue step on the determination object with his or her foot may be indicated by the thickness of the mobile object. A mobile object does not necessarily appear from directly above its destination determination object, but may appear from a position other than directly above. Furthermore, the moving direction of the mobile object and the position of the determination object can also be set arbitrarily.

No determination objects may be displayed at the determination positions. For example, when a determination position is a position on the floor surface, the timing and position at which the mobile object reaches the floor surface are the content of an instruction for the user U to perform a motion. For example, if a mobile object having a certain thickness (for example, the same length as the height of the user U) in an oblique direction (for example, a direction tilted at 45 degrees with respect to the vertical direction) rather than in the vertical direction is moved toward the floor surface (the determination position) in the vertical direction, a position on the floor surface at which the mobile object reaches the floor surface changes over time from a position in the XY plane at which the bottom of the mobile object reaches the floor surface to a position in the XY plane at which the top of the mobile object reaches the floor surface. Thus, a mobile object having a certain thickness in a diagonal direction may be used to issue an instruction to move the position to be stepped on with the foot.

The determination position is not limited to the floor surface and can be set, for example, at any position between the floor surface and the ceiling. The height of the user U may be detected and the height of the determination position may be set according to the height of the user U. Alternatively, a displayed mobile object itself may instruct the user U to perform a motion without providing a determination position. For example, the position of the mobile object when it appears or the position and timing of the mobile object when it is moving may be an instruction for the user U to perform a motion. For example, a trajectory of movement of a mobile object may indicate a trajectory of the motion of the user U (for example, a trajectory of hand motion).

A configuration in which the game device 10 and the game device TOA configured as a see-through HMD described in the first and second embodiments include the imaging unit 11 has been described. However, the imaging unit 11 may be installed as a separate device from the game device 10 and the game device 10A at a different location where it can image the user U playing a dance game. In this case, a device including the imaging unit 11 installed at the different location is communicatively connected to the game device 10 and the game device 10A by wire or wirelessly. A configuration in which the HMD 20C includes the imaging unit 21C, which is a component corresponding to the imaging unit 11, in the game system 1C including the game device 10C and the HMD 20C described in the third embodiment has also been described. However, similarly, the imaging unit 21C may be installed as a separate device from the HMD 20C at a different location where it can image the user U playing a dance game. In this case, a device including the imaging unit 21C installed at the different location is communicatively connected to the HMD 20C or the game device 10C by wire or wirelessly. The imaging unit 21C may also be included in the game device 10C.

In the configuration of the game device 10D described in the fourth embodiment, the front camera 11DA provided as an imaging unit is used to image the user U playing a dance game. However, it is also possible to employ a configuration in which a device including an imaging unit installed at a different location from the game device 10D is used to image the user U. In this case, the device including the imaging unit installed at the different location is communicatively connected to the game device 10D by wire or wirelessly.

The processing of the control unit 150 (150A, 150C, 150D) described above may be performed by recording a program for implementing the functions of the control unit 150 (150A, 150C, 150D) on a computer-readable recording medium and causing a computer system to read and execute the program recorded on the recording medium. Here, “causing a computer system to read and execute the program recorded on the recording medium” includes installing the program on the computer system. The term “computer system” referred to here includes an OS or hardware such as peripheral devices. The “computer system” may include a plurality of computer devices connected via the Internet, a WAN, a LAN, or a network including a communication line such as a dedicated line. The term “computer readable recording medium” refers to a portable medium such as a flexible disk, a magneto-optical disc, a ROM, or a CD-ROM, a storage device such as a hard disk provided in the computer system, or the like. In this way, the recording medium storing the program may be a non-transitory recording medium such as a CD-ROM. The recording medium also includes an internally or externally provided recording medium that a distribution server can access to distribute the program. The code of the program stored in the recording medium of the distribution server may differ from the code of a program in a format that can be executed by a terminal device. That is, the format in which the program is stored in the distribution server does not matter as long as it can be downloaded from a distribution server and installed on a terminal device in an executable form. A configuration in which a program is divided into a plurality of parts and the plurality of parts are combined on a terminal device after being downloaded at different times may also be employed and the plurality of parts into which the program is divided may be distributed by different distribution servers. The “computer readable recording medium” is assumed to include something that holds a program for a certain period of time, like an internal volatile memory (RAM) of a computer system that serves as a server or a client in the case where the program is transmitted via a network. The program described above may be one for implementing some of the above-described functions. The program may also be a so-called difference file (difference program) that can implement the above-described functions in combination with a program already recorded in the computer system.

Also, some or all of the functions of the control unit 150 (150A, 150C, 150D) may be implemented as an integrated circuit such as large scale integration (LSI). The functions described above may be individually implemented as processors or some or all of the functions may be integrated and implemented as a processor. The circuit integration is not limited to LSI and may be implemented by a dedicated circuit or a general-purpose processor. If an integrated circuit technology that replaces LSI emerges due to advances in semiconductor technology, an integrated circuit based on the technology may be used.

In the above embodiments, at least a part of the data stored in the storage unit 14 (14C, 14D) included in the game device 10 (10A, 10C, 10D) may be stored in an externally connected storage device. The externally connected storage device is a storage device connected to the game device 10 (10A, 10C, 10D) by wire or wirelessly. For example, the externally connected storage device may be a storage device connected via a universal serial bus (USB), a wireless local area network (LAN), a wired LAN, or the like or may be a storage device (a data server) connected via the Internet or the like. This storage device (data server) connected via the Internet or the like may be used using cloud computing.

A component corresponding to at least a part of each unit included in the control unit 150 (150A, 150C, 150D) may be included in a server connected via the Internet or the like. For example, the above embodiments can also be applied to a so-called cloud game in which the processing of a game such as a dance game is executed on a server.

In above embodiments, a dance game which is an example of a music game has been described as an example, but the present invention is not limited to dance games. For example, the present invention can be applied to all music games in which operations are performed on objects that appear in accordance with music. The present invention can also be applied to games in which operations such as punching, kicking, slapping, or hitting using a weapon are performed on objects that appear at predetermined timings in addition to music games.

### Additional Notes

From the above description, the present invention can be understood, for example, as follows. The reference numerals of the accompanying drawings are conveniently added in parentheses to facilitate understanding of the present invention, but the present invention is not limited to the shown embodiments.

### Additional Note A1

A game program according to an aspect of the present invention causes a computer, which performs processing of a game that is playable using an image output device (10, 10A, 20C) that is worn on a head of a user (U) to output an image to the user such that the image is visible to the user while a real space is visible, to perform the steps of (S101, S301, S401) acquiring a captured image of the real space, (S103, S405) generating a virtual space corresponding to the real space from the captured image, (S105, S109, S407, S411) arranging an instruction object that instructs the user to perform a motion at a position that is based on a reference position (K1, K2) corresponding to the user in the virtual space such that the instruction object is visible to the user, (S203) displaying the virtual space in which at least the instruction object is arranged in association with the real space, (S303) detecting a motion of at least a part of a body of the user from the captured image, and (S305) evaluating the detected motion based on a timing and position that are based on the instruction object arranged in the virtual space.

According to the configuration of Additional Note A1, in the game processing for evaluating a motion of the user based on the timing and position that are based on an instruction object that instructs the user to perform the motion, the game program makes the instruction object visible to the user in association with the real space by wearing an image output device such as an HMD on his or her head and therefore, with a simple configuration, it is possible to guide the user as to the content of a motion to be performed such that the user can play more intuitively.

### Additional Note A2

An aspect of the present invention is the game program according to Additional Note A1, wherein the reference position includes a first reference position (K1) in the virtual space corresponding to a position of the user (U) wearing the image output device (10, 10A, 20C), and the first reference position is based on a position of the image output device in the virtual space.

According to the configuration of Additional Note A2, the game program can display instruction objects in association with the real space based on the position of the user playing the game, such that instructions for the user to perform motions can feel realistic, allowing for more intuitive play.

### Additional Note A3

An aspect of the present invention is the game program according to Additional Note A2, wherein the step (S105, S109, S407, S411) of arranging includes limiting the position at which the instruction object is arranged to a part of the virtual space depending on an orientation of the user (U) wearing the image output device (10, 10A, 20C).

According to the configuration of Additional Note A3, the game program does not issue an instruction to perform a motion outside the range of the field of view of the user (for example, behind the user), such that the user can play without worrying about what is outside the range of the field of view (for example, behind the user) during play and thus it is possible to prevent the difficulty level of play from becoming too high.

### Additional Note A4

An aspect of the present invention is the game program according to Additional Note A1, wherein the game program causes the computer to further perform the step (S403) of detecting an image (UK) corresponding to the user (U) from the captured image, and the reference position includes a second reference position (K2) in the virtual space of the detected image corresponding to the user.

According to the configuration of Additional Note A4, by wearing an image output device such as an HMD on the head, the game program can display instruction objects that instruct the user to perform motions, for example, around the virtual image of the user (the user image UK) reflected in the mirror and thus, with a simple configuration, it is possible to guide the user as to the content of a motion to be performed such that the user can play more intuitively. For example, the game program allows the user to simultaneously look down and view instruction objects displayed around the user image UK (for example, in front of, behind, to the left, and to the right of the user image UK) without limiting positions where the instruction objects are arranged to a part of the virtual space and therefore it is possible to diversify the types of motions that the user is instructed to perform during play. Also, the game program can evaluate the motion of the user without looking at his or her feet and instruction objects that are located below and therefore it is possible to prevent the user U from having difficulty dancing.

### Additional Note A5

An aspect of the present invention is the game program according to Additional Note A2 or A3, wherein the game program causes the computer to further perform the step (S403) of detecting an image (UK) corresponding to the user (U) from the captured image, and the reference position includes a second reference position (K2) in the virtual space of the detected image corresponding to the user.

According to the configuration of Additional Note A5, by wearing an image output device such as an HMD on the head, the game program can display instruction objects that instruct the user to perform motions, for example, around the virtual image of the user (the user image UK) reflected in the mirror and thus, with a simple configuration, it is possible to guide the user as to the content of a motion to be performed such that the user can play more intuitively. For example, the game program allows the user to simultaneously look down and view instruction objects displayed around the user image UK (for example, in front of, behind, to the left, and to the right of the user image UK) without limiting positions where the instruction objects are arranged to a part of the virtual space and therefore it is possible to diversify the types of motions that the user is instructed to perform during play. Also, the game program can evaluate the motion of the user without looking at his or her feet and instruction objects that are located below and therefore it is possible to prevent the user U from having difficulty dancing. In addition, the game program displays instruction objects around the user playing the game and around the virtual image of the user reflected, for example, in the mirror, thus allowing the user to play while arbitrarily selecting whichever of the instruction objects is easier to play.

### Additional Note A6

An aspect of the present invention is the game program according to Additional Note A5, wherein the step (S105, S109, S407, S411) of arranging includes reducing visibility of the instruction object arranged at the position that is based on the first reference position (K1) or not arranging the instruction object at the position that is based on the first reference position (K1) when arranging the instruction object at a position that is based on the second reference position (K2) in the virtual space.

According to the configuration of Additional Note A6, the game program can improve the visibility of instruction objects because it prevents instruction objects displayed at positions (around the virtual image of the user reflected in the mirror MR) that are based on the second reference position (for example, the reference position K2) from being hidden by instruction objects displayed at positions (around the user U) that are based on the first reference position (for example, the reference position K1).

### Additional Note A7

An aspect of the present invention is the game program according to any one of Additional Notes A4 to or A6, wherein the detected image (UK) corresponding to the user (U) is an image of the user reflected in a mirror (MR) present facing the user, and the step (S105, S109, S407, S411) of arranging includes reversing a front-back orientation with respect to the second reference position (K2) when arranging the instruction object at a position that is based on the second reference position in the virtual space.

According to the configuration of Additional Note A7, the game program can display instruction objects in correspondence with the orientation of the virtual image of the user (the user image UK) reflected in the mirror, such that it is possible to guide the user as to the content of a motion to be performed such that the user can play intuitively while looking at the mirror.

### Additional Note A8

An aspect of the present invention is the game program according to any one of Additional Notes A1 to A7, wherein the step (S105, S109, S407, S411) of arranging includes moving the instruction object arranged at a predetermined position in the virtual space toward a predetermined determination position, and the step (S305) of evaluating includes evaluating the detected motion based on the determination position and a timing at which the instruction object moving in the virtual space reaches the determination position.

According to the configuration of Additional Note A8, the game program can evaluate whether the user was able to perform a motion as instructed using the captured image.

### Additional Note A9

An aspect of the present invention is the game program according to any one of Additional Notes A1 to A8, wherein content of a motion that the user (U) is instructed to perform varies depending on a type of the instruction object.

According to the configuration of Additional Note A9, the game program can diversify the content of the motion that the user performs during play and can provide a highly interesting game.

### Additional Note A10

A game processing method according to an aspect of the present invention is a game processing method performed by a computer that performs processing of a game that is playable using an image output device (10, 10A, 20C) that is worn on a head of a user (U) to output an image to the user such that the image is visible to the user while a real space is visible, the game processing method including the steps of (S101, S301, S401) acquiring a captured image of the real space, (S103, S405) generating a virtual space corresponding to the real space from the captured image, (S105, S109, S407, S411) arranging an instruction object that instructs the user to perform a motion at a position that is based on a reference position (K1, K2) corresponding to the user in the virtual space such that the instruction object is visible to the user, (S203) displaying the virtual space in which at least the instruction object is arranged in association with the real space, (S303) detecting a motion of at least a part of a body of the user from the captured image, and (S305) evaluating the detected motion based on a timing and position that are based on the instruction object arranged in the virtual space.

According to the configuration of Additional Note A10, in the game processing for evaluating a motion of the user based on the timing and position that are based on an instruction object that instructs the user U to perform the motion, the game processing method makes the instruction object visible to the user in association with the real space by wearing an image output device such as an HMD on his or her head and therefore, with a simple configuration, it is possible to guide the user as to the content of a motion to be performed such that the user can play more intuitively.

### Additional Note A11

A game device (10, 10A, 10C) according to an aspect of the present invention is a game device that performs processing of a game that is playable using an image output device (10, 10A, 20C) that is worn on a head of a user (U) to output an image to the user such that the image is visible to the user while a real space is visible, the game device including an acquiring unit (151, S101, S301, S401) configured to acquire a captured image of the real space, a generating unit (152, S103, S405) configured to generate a virtual space corresponding to the real space from the captured image acquired by the acquiring unit, an arranging unit (154, S105, S109, S407, S411) configured to arrange an instruction object that instructs the user to perform a motion at a position that is based on a reference position (K1, K2) corresponding to the user in the virtual space generated by the generating unit such that the instruction object is visible to the user, a display control unit (156, S203) configured to display the virtual space in which at least the instruction object is arranged in association with the real space, a detecting unit (157, S303) configured to detect a motion of at least a part of a body of the user from the captured image acquired by the acquiring unit, and an evaluating unit (158, S305) configured to evaluate the motion detected by the detecting unit based on a timing and position that are based on the instruction object arranged in the virtual space.

According to the configuration of Additional Note A11, in the game processing for evaluating a motion of the user based on the timing and position that are based on an instruction object that instructs the user U to perform the motion, the game device makes the instruction object visible to the user in association with the real space by wearing an image output device such as an HMD on his or her head and therefore, with a simple configuration, it is possible to guide the user as to the content of a motion to be performed such that the user can play more intuitively.

### Additional Note B1

A game program according to an aspect of the present invention causes a computer to perform the steps of (S501, S701) acquiring a captured image of a real space, (S505) generating a virtual space corresponding to the real space from the captured image, (S507, S511) arranging an instruction object that instructs a user (U) to perform a motion at a position that is based on a reference position (K3) corresponding to the user in the virtual space such that the instruction object is visible to the user, (S603) causing a display unit (12D, 30D) to display a composite image combining the captured image and an image of the instruction object arranged in the virtual space, (S703) detecting a motion of at least a part of a body of the user from the captured image, and (S705) evaluating the detected motion based on a timing and position that are based on the instruction object arranged in the virtual space.

According to the configuration of Additional Note B1, in the game processing for evaluating a motion of the user based on the timing and position that are based on an instruction object that instructs the user to perform the motion, the game program causes a display unit of a smartphone, a home television, or the like to visibly display a composite image that combines instruction objects with a captured image of the user and therefore, with a simple configuration, it is possible to guide the user as to the content of a motion to be performed such that the user can play more intuitively.

### Additional Note B2

An aspect of the present invention is the game program according to Additional Note B1, wherein the step (S603) of displaying includes reversing the composite image left to right and causing the display unit (12D, 30D) to display the reversed composite image.

According to the configuration of Additional Note B2, the game program allows the user to play while looking at the display unit (the monitor) with the same feeling as looking at a mirror.

### Additional Note B3

An aspect of the present invention is the game program according to Additional Note B1 or B2, wherein the step (S507, S511) of arranging includes moving the instruction object arranged at a predetermined position in the virtual space toward a predetermined determination position, and the step (S705) of evaluating includes evaluating the detected motion based on the determination position and a timing at which the instruction object moving in the virtual space reaches the determination position.

According to the configuration of Additional Note B3, the game program can evaluate whether the user was able to perform a motion as instructed using the captured image.

### Additional Note B4

An aspect of the present invention is the game program according to any one of Additional Notes B1 to B3, wherein content of a motion that the user (U) is instructed to perform varies depending on a type of the instruction object.

According to the configuration of Additional Note B4, the game program can diversify the content of the motion that the user performs during play and can provide a highly interesting game.

### Additional Note B5

A game processing method according to an aspect of the present invention is a game processing method performed by a computer, the game processing method including the steps of (S501, S701) acquiring a captured image of a real space, (S505) generating a virtual space corresponding to the real space from the captured image, (S507, S511) arranging an instruction object that instructs a user (U) to perform a motion at a position that is based on a reference position (K3) corresponding to the user in the virtual space such that the instruction object is visible to the user, (S603) causing a display unit (12D, 30D) to display a composite image combining the captured image and an image of the instruction object arranged in the virtual space, (S703) detecting a motion of at least a part of a body of the user from the captured image, and (S705) evaluating the detected motion based on a timing and position that are based on the instruction object arranged in the virtual space.

According to the configuration of Additional Note B5, in the game processing for evaluating a motion of the user based on the timing and position that are based on an instruction object that instructs the user to perform the motion, the game processing method causes a display unit of a smartphone, a home television, or the like to visibly display a composite image that combines instruction objects with a captured image of the user and therefore, with a simple configuration, it is possible to guide the user as to the content of a motion to be performed such that the user can play more intuitively.

### Additional Note B6

A game device (10D) according to an aspect of the present invention includes an acquiring unit (151D, S501, S701) configured to acquire a captured image of a real space, a generating unit (152D) configured to generate a virtual space corresponding to the real space from the captured image acquired by the acquiring unit, an arranging unit (154D, S507, S511) configured to arrange an instruction object that instructs a user (U) to perform a motion at a position that is based on a reference position (K3) corresponding to the user in the virtual space generated by the generating unit such that the instruction object is visible to the user, a display control unit (156D, S603) configured to cause a display unit (12D, 30D) to display a composite image combining the captured image and an image of the instruction object arranged in the virtual space, a detecting unit (157D, S703) configured to detect a motion of at least a part of a body of the user from the captured image acquired by the acquiring unit, and an evaluating unit (158D, S705) configured to evaluate the motion detected by the detecting unit based on a timing and position that are based on the instruction object arranged in the virtual space.

According to the configuration of Additional Note B6, in the game processing for evaluating a motion of the user based on the timing and position that are based on an instruction object that instructs the user to perform the motion, the game device causes a display unit of a smartphone, a home television, or the like to visibly display a composite image that combines instruction objects with a captured image of the user and therefore, with a simple configuration, it is possible to guide the user as to the content of a motion to be performed such that the user can play more intuitively.

### REFERENCE SIGNS LIST

1C Game system
10, 10A, 10C, 10D Game device
11 Imaging unit
11DA Front camera
11DB Back camera
12, 12D Display unit
13, 13D Sensor
14, 14C, 14D Storage unit
15, 15C, 15D CPU
16, 16C, 16D Communication unit
17, 17D Sound output unit
18D Image output unit
20C HMD
21C Imaging unit
22C Display unit
23C Sensor
24C Storage unit
25C CPU
26C Communication unit
27C Sound output unit
150, 150A, 150C, 150D Control unit
151, 151D Image acquiring unit
152, 152D Virtual space generating unit
153A User image detecting unit
153D User detecting unit
154, 154A, 154D Object arranging unit
155 Line-of-sight direction detecting unit
156, 156D Display control unit
157, 157D Motion detecting unit
158, 158D Evaluating unit

1. A non-temporary storage medium storing a game program for a computer that performs processing of a game that is playable using an image output device that is worn on a head of a user to output an image to the user such that the image is visible to the user while a real space is visible, the game program causing the computer to perform the steps of:
acquiring a captured image of the real space;
generating a virtual space corresponding to the real space from the captured image;
arranging an instruction object that instructs the user to perform a motion at a position that is based on a reference position corresponding to the user in the virtual space such that the instruction object is visible to the user;
displaying the virtual space in which at least the instruction object is arranged in association with the real space;
detecting a motion of at least a part of a body of the user from the captured image; and
evaluating the detected motion based on a timing and position that are based on the instruction object arranged in the virtual space.

2. The non-temporary storage medium according to claim 1, wherein the reference position includes a first reference position in the virtual space corresponding to a position of the user wearing the image output device, and
the first reference position is based on a position of the image output device in the virtual space.

3. The non-temporary storage medium according to claim 2, wherein the step of arranging includes limiting the position at which the instruction object is arranged to a part of the virtual space depending on an orientation of the user wearing the image output device.

4. The non-temporary storage medium according to claim 1, wherein the game program causes the computer to further perform the step of detecting an image corresponding to the user from the captured image, and
the reference position includes a second reference position in the virtual space of the detected image corresponding to the user.

5. The non-temporary storage medium according to claim 2, wherein the game program causes the computer to further perform the step of detecting an image corresponding to the user from the captured image, and
the reference position includes a second reference position in the virtual space of the detected image corresponding to the user.

6. The non-temporary storage medium according to claim 5, wherein the step of arranging includes reducing visibility of the instruction object arranged at the position that is based on the first reference position or not arranging the instruction object at the position that is based on the first reference position when arranging the instruction object at a position that is based on the second reference position in the virtual space.

7. The non-temporary storage medium according to claim 4, wherein the detected image corresponding to the user is an image of the user reflected in a mirror present facing the user, and
the step of arranging includes reversing a front-back orientation with respect to the second reference position when arranging the instruction object at a position that is based on the second reference position in the virtual space.

8. The non-temporary storage medium according to claim 1, wherein the step of arranging includes moving the instruction object arranged at a predetermined position in the virtual space toward a predetermined determination position, and
the step of evaluating includes evaluating the detected motion based on the determination position and a timing at which the instruction object moving in the virtual space reaches the determination position.

9. The non-temporary storage medium according to claim 1, wherein content of a motion that the user is instructed to perform varies depending on a type of the instruction object.

10. A game processing method performed by a computer that performs processing of a game that is playable using an image output device that is worn on a head of a user to output an image to the user such that the image is visible to the user while a real space is visible, the game processing method comprising the steps of:
acquiring a captured image of the real space;
generating a virtual space corresponding to the real space from the captured image;
arranging an instruction object that instructs the user to perform a motion at a position that is based on a reference position corresponding to the user in the virtual space such that the instruction object is visible to the user;
displaying the virtual space in which at least the instruction object is arranged in association with the real space;
detecting a motion of at least a part of a body of the user from the captured image; and
evaluating the detected motion based on a timing and position that are based on the instruction object arranged in the virtual space.

11. A game device that performs processing of a game that is playable using an image output device that is worn on a head of a user to output an image to the user such that the image is visible to the user while a real space is visible, the game device comprising:
an acquiring unit configured to acquire a captured image of the real space;
a generating unit configured to generate a virtual space corresponding to the real space from the captured image acquired by the acquiring unit;
an arranging unit configured to arrange an instruction object that instructs the user to perform a motion at a position that is based on a reference position corresponding to the user in the virtual space generated by the generating unit such that the instruction object is visible to the user;
a display control unit configured to display the virtual space in which at least the instruction object is arranged in association with the real space;
a detecting unit configured to detect a motion of at least a part of a body of the user from the captured image acquired by the acquiring unit; and
an evaluating unit configured to evaluate the motion detected by the detecting unit based on a timing and position that are based on the instruction object arranged in the virtual space.

12. A game program causing a computer to perform the steps of:
acquiring a captured image of a real space;
generating a virtual space corresponding to the real space from the captured image;
arranging an instruction object that instructs a user to perform a motion at a position that is based on a reference position corresponding to the user in the virtual space such that the instruction object is visible to the user;
causing a display unit to display a composite image combining the captured image and an image of the instruction object arranged in the virtual space;
detecting a motion of at least a part of a body of the user from the captured image; and
evaluating the detected motion based on a timing and position that are based on the instruction object arranged in the virtual space.

13. The game program according to claim 12, wherein the step of displaying includes reversing the composite image left to right and causing the display unit to display the reversed composite image.

14. The game program according to claim 12, wherein the step of arranging includes moving the instruction object arranged at a predetermined position in the virtual space toward a predetermined determination position, and
the step of evaluating includes evaluating the detected motion based on the determination position and a timing at which the instruction object moving in the virtual space reaches the determination position.

15. The game program according to claim 1, wherein content of a motion that the user is instructed to perform varies depending on a type of the instruction object.

16. A game processing method performed by a computer, the game processing method comprising the steps of:
acquiring a captured image of a real space;
generating a virtual space corresponding to the real space from the captured image;
arranging an instruction object that instructs a user to perform a motion at a position that is based on a reference position corresponding to the user in the virtual space such that the instruction object is visible to the user;
causing a display unit to display a composite image combining the captured image and an image of the instruction object arranged in the virtual space;
detecting a motion of at least a part of a body of the user from the captured image; and
evaluating the detected motion based on a timing and position that are based on the instruction object arranged in the virtual space.

17. A game device comprising:
an acquiring unit configured to acquire a captured image of a real space;
a generating unit configured to generate a virtual space corresponding to the real space from the captured image acquired by the acquiring unit;
an arranging unit configured to arrange an instruction object that instructs a user to perform a motion at a position that is based on a reference position corresponding to the user in the virtual space generated by the generating unit such that the instruction object is visible to the user;
a display control unit configured to cause a display unit to display a composite image combining the captured image and an image of the instruction object arranged in the virtual space;
a detecting unit configured to detect a motion of at least a part of a body of the user from the captured image acquired by the acquiring unit; and
an evaluating unit configured to evaluate the motion detected by the detecting unit based on a timing and position that are based on the instruction object arranged in the virtual space.
